(19) United States
(12) Patent Application Publication
(10) Pub. No.: US 2024/0412000 A1
(43) Pub. Date: Dec. 12, 2024

(54) LARGE LANGUAGE MODEL CONTROLLER

(71) Applicant: Salesforce, Inc., San Francisco, CA (US)

(72) Inventor: Lik Mui, San Carlos, CA (US)

(21) Appl. No.: 18/373,132

(22) Filed: Sep. 26, 2023

Related U.S. Application Data
(60) Provisional application No. 63/507,348, filed on Jun. 9, 2023.

(51) Int. Cl. G06F 40/35; G06F 16/953; G06F 40/279

(52) U.S. Cl. CPC G06F 40/35; G06F 16/953; G06F 40/279

(57) ABSTRACT

An application server or other processing entity may receive, via a cloud-based platform, user input that may include at least one request for data. The application server may classify the user input into a first of a plurality of deterministic-stochastic spectrum classifications based on the user input and a probability of mapping the at least one request for data to at least one data location. The application server may retrieve the data from the at least one data location and based on the first deterministic-stochastic spectrum classification. The application server may transmit, based on the first deterministic-stochastic spectrum classification and the user input, an input to a large language model. The application server may present a response to the user input, where the response is based on a combination of an output of the large language model and the data retrieved from the at least one data location.

### CROSS REFERENCES

The present application for patent claims priority to U.S. Provisional Patent Application No. 63/507,348 by Mui, entitled “LARGE LANGUAGE MODEL CONTROLLER,” filed Jun. 9, 2023, assigned to the assignee hereof, and expressly incorporated by reference herein.

### FIELD OF TECHNOLOGY

The present disclosure relates generally to database systems and data processing, and more specifically to large language model controller.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

Some systems may utilize large language models (LLMs). However, such approaches may be improved.

### BRIEF DESCRIPTION OF THE DRAWINGS

FIG. 1 illustrates an example of a data processing system that supports a large language model controller in accordance with examples as disclosed herein.

FIG. 2 shows an example of a spectrum diagram that supports a large language model controller in accordance with examples as disclosed herein.

FIG. 3 shows an example of a user interface that supports a large language model controller in accordance with examples as disclosed herein.

FIG. 4 shows an example of a system that supports a large language model controller in accordance with examples as disclosed herein.

FIG. 5 shows an example of a user interface that supports a large language model controller in accordance with examples as disclosed herein.

FIG. 6 shows an example of a system that supports a large language model controller in accordance with examples as disclosed herein.

FIG. 7 shows an example of a user interface that supports a large language model controller in accordance with examples as disclosed herein.

FIG. 8 shows an example of a system that supports a large language model controller in accordance with examples as disclosed herein.

FIG. 9 shows an example of a user interface that supports a large language model controller in accordance with examples as disclosed herein.

FIG. 10 shows an example of a system that supports a large language model controller in accordance with examples as disclosed herein.

FIG. 11 shows an example of a process flow that supports a large language model controller in accordance with examples as disclosed herein.

FIG. 12 shows a block diagram of an apparatus that supports a large language model controller in accordance with examples as disclosed herein.

FIG. 13 shows a block diagram of an LLM manager that supports a large language model controller in accordance with examples as disclosed herein.

FIG. 14 shows a diagram of a system including a device that supports a large language model controller in accordance with examples as disclosed herein.

FIGS. 15 through 18 show flowcharts illustrating methods that support large language model controller in accordance with examples as disclosed herein.

### DETAILED DESCRIPTION

The rapid advancement of artificial intelligence (AI) has led to the development of increasingly sophisticated natural language processing (NLP) techniques, including large language models (LLMs) (e.g., publicly-accessible LLMs, locally-hosted LLMs, private LLMs, or other LLMs). These models have been utilized for a variety of tasks, including translation, text generation, sentiment analysis, and more. However, some approaches utilizing LLMs or other AI do not sufficiently bridge the gap between high-level user intents and the execution of corresponding tasks in various tools and systems. Existing solutions often lack the ability to interpret natural language queries effectively and translate them into domain-specific queries suitable for different tools, systems, application programming interfaces (APIs), or implementations. Further, in some situations, it may be desirable to provide more deterministic results in response to a natural language query, whereas in other situations a more stochastic or creative result may be desired. Large language models also suffer from providing incorrect responses (e.g., hallucinating), and the user cannot easily tell if the response provided by an LLM contains correct or fictional data. As such, typical approaches do not provide mechanisms for receiving such diverse user input and providing the appropriate results.

In accordance with aspects of the present disclosure, and to resolve one or more of the described problems with utilizing LLMs, a system is described that can leverage the generative capabilities of an LLM (e.g., a publicly-accessible LLM, a locally-hosted LLM, a private LLM, or other LLM) while ensuring accuracy of the data within the response. Such a system may greatly improve the usability of LLMs in a wide range of use cases that require a high level of confidence in the response that an LLM provides. In some examples, a system may interpret natural language queries (or any other form of input such as a direct API call) and classify requested tasks or data with deterministic-stochastic spectrum classifications that indicate a how deterministic or stochastic the tasks or data contained with the query or response is. For example, some tasks may be more deterministic or require a more deterministic response (e.g., retrieving data from a database) and other tasks may be more stochastic or may allow for a wider range of creative responses (e.g., writing a warm invitation letter to a potential client). By classifying the queries and/or data, the system may then map the request to the proper tool or operation for the task, and in some examples leverage non-LLM tools for some tasks (e.g., querying data from internal or external sources) while leveraging LLM tools for other tasks (e.g., compiling the results from a database query to a natural sounding response, among other examples). Examples of such tools may include (but are not limited to) LLMs, structured query language (SQL) databases, semantic search systems, various APIs, one or more other tools, or any combination thereof. The system may then obtain and present the results to the user, and, as the correct tool was determined and used to generate the response, the results may be more accurate and helpful to the user. The increased accuracy and confidence of LLM responses using the techniques described herein may be useful in a wide range of use cases including but not limited to enterprise-level tools and systems, legal applications, medical applications, or any other applications in which accuracy of responses is desired.

Aspects of the disclosure are initially described in the context of an environment supporting an on-demand database service. Aspects of the disclosure are then described with reference to a spectrum diagram, user interfaces, systems, and a process flow. Aspects of the disclosure are further illustrated by and described with reference to apparatus diagrams, system diagrams, and flowcharts that relate to large language model controller.

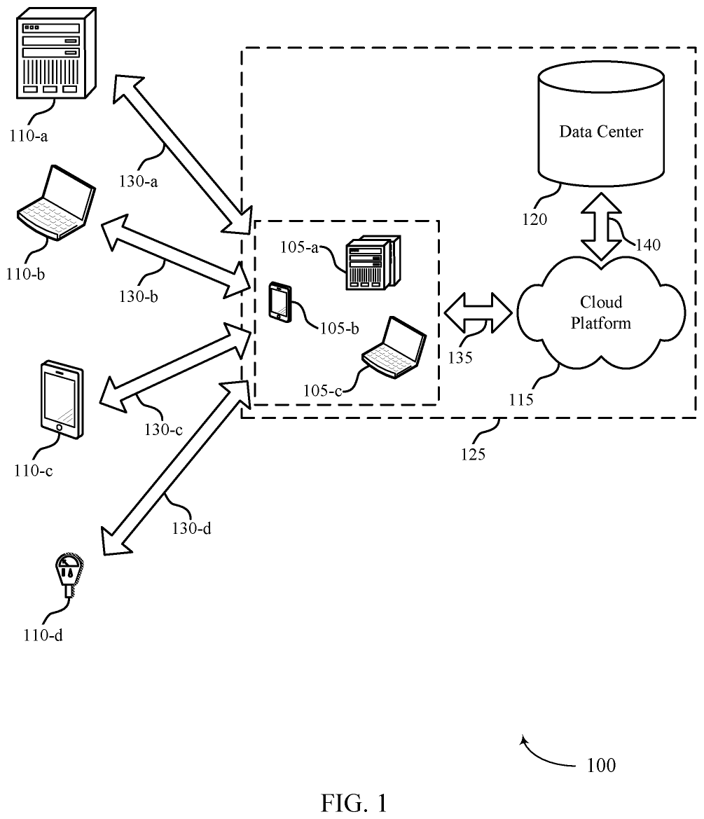

FIG. 1 illustrates an example of a system 100 for cloud computing that supports a large language model controller in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

The cloud platform 115 may receive user input (e.g., from a cloud client 105) that may include a request for data or some other type of prompt or query. The cloud platform 115 may classify the user input into a deterministic-stochastic spectrum classification based on one or more characteristics of the user input so that the cloud platform 115 may perform one or more appropriate operations to retrieve the data requested in the user input. The cloud platform 115 may retrieve the data from a data location based on the deterministic-stochastic spectrum classification, one or more characteristics of the user input, or both. The cloud platform 115 may transmit an input to an LLM to obtain language or content to provide in a response to the user input. Such language or content may incorporate the retrieved data, or the language or content may be the data (e.g., in cases where data was not retrieved from a database separate from the LLM). The cloud platform 115 may transmit the response to the user input back to the cloud client 105 that transmitted the user input.

Some approaches to using AI and NLP techniques do not account for different processing domains (e.g., deterministic domains or tasks versus stochastic domains or tasks) that may be associated with different input formats, characteristics, or information. For example, some tasks may involve both AI-determined actions and user-determined actions in different amounts. Further, some tasks may be more deterministic and other tasks may be more stochastic or creative. Further, some approaches may not interpret natural language input correctly and may pursue a processing path or task using incorrect models or tools, as the true intent behind the user's natural language input may not be analyzed or determined correctly. As such, some approaches do not consider these differences, and may provide incorrect or inapplicable results to natural language queries.

The subject matter described herein analyzes natural language input (or other forms of input such as a direct API call) to classify a request, a task, associated data, or any combination thereof to determine where such items may fall along a deterministic-stochastic spectrum. By determining where a request, task, or data may fall along the spectrum, a system may employ the use of different tools or combinations of tools to fulfill the request or retrieve the requested data that may be better suited for responding to the request. For example, an LLM (e.g., a publicly-accessible LLM, a locally-hosted LLM, a private LLM, or other LLM) may be better suited to a more creative, stochastic request, while an SQL query may be better suited for a more deterministic request, and a vector distance approach may be better suited for a task falling in the middle of a deterministic-stochastic spectrum. Further, an LLM may use or expect a different type of input format than a SQL database or a semantic search system, and the subject matter herein may involve translation of the natural language input to a format that may be expected by different processing tools and formats. In this way, interpretation of natural language input and assignments of processing tools to perform tasks included in the natural language input may be improved.

For example, a user may generate natural language input that indicates a task to be performed by the system. The system may receive and analyze this natural language input to determine which processing tools may be used to perform the task indicated by the user. This determination may be made through the use of deterministic-stochastic spectrum and assignment or correlation of such a deterministic-stochastic spectrum classification of the request, task, or associated data. The system may then transmit a query to the appropriate processing tool(s) and may generate a request of the appropriate format for the appropriate processing tool(s). The system may receive a response from the processing tools and transmit the response back to the user. In some examples, the response may be partially or completely generated by an LLM (e.g., a publicly-accessible LLM, a locally-hosted LLM, a private LLM, or other LLM). In some examples, the LLM may offer additional analysis or summary of information processed by the LLM. In this way, the user inputs natural language input and the system determines which processing domains or tools are most appropriate based on the user input and the user receives the response that aligns with the user's intent in providing the input.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

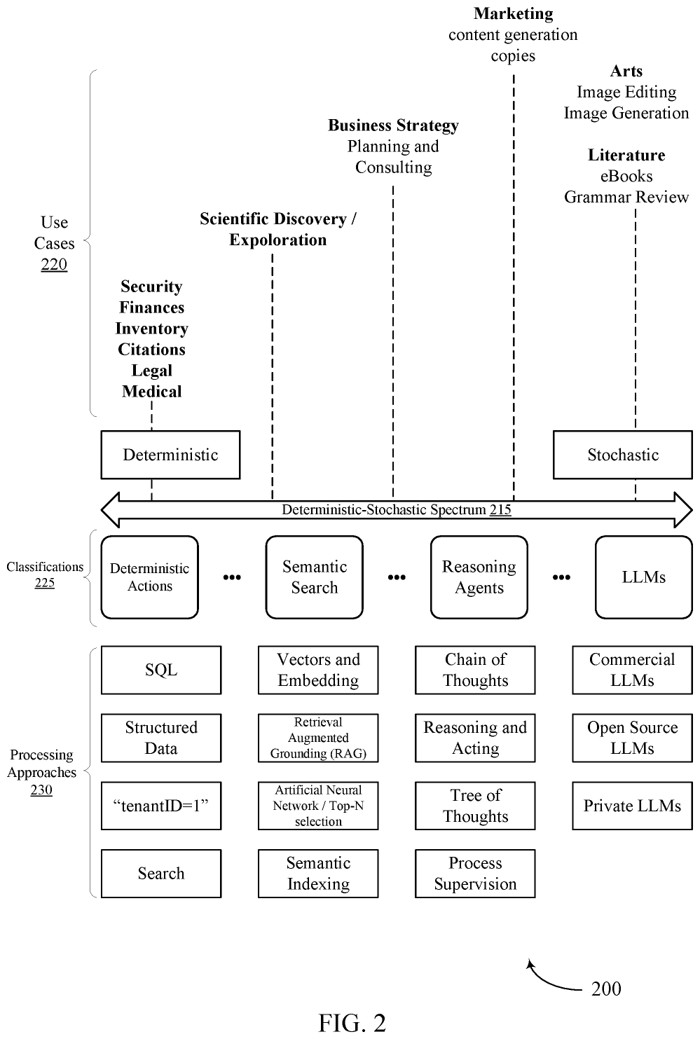

FIG. 2 shows an example of a spectrum diagram 200 that supports a large language model controller in accordance with examples as disclosed herein.

The spectrum diagram 200 describes a deterministic-stochastic spectrum 215 and associated use cases 220, classifications 225, and processing approaches 230. The deterministic-stochastic spectrum 215 may describe a measure of how deterministic or stochastic the use cases 220, classifications 225, and processing approaches 230 may be. For example, the use cases 220 may include use cases that are more deterministic, are more stochastic, or a combination thereof. For example, use cases involving security, finances, inventory, citations, legal, or medical aspects may be more deterministic and it may, in some cases, be preferable (or required) to avoid hallucination or incorrect responses in the use of LLMs in such use cases. In some contexts, a use case 220, classification 225, processing approach 230, query, task, user input, or other element or operation that is more deterministic may involve less or no hallucination or improvisation by a LLM (e.g., a publicly-accessible LLM, a locally-hosted LLM, a private LLM, or other LLM) or other processing entity. In contrast, more stochastic use cases 220 may involve arts and literature, such as image editing, image generation, literature generation, grammar review; and other more “creative” use cases 220 in which it may be desirable for an LLM to create or generate information (e.g., as opposed to retrieving or reproducing information).

A system may receive user input to the system. The system may receive the user input via a user interface, such as a command line or a graphical user interface, via an API, a structured input (e.g., a structured query), one or more other methods of providing input, or any combination thereof. Such user input may include a request for data, a request for creation, a request for one or more LLM operations, a request for information, or any combination thereof. The system may classify the user input into one or more of the classifications 225 that lie at different points along the deterministic-stochastic spectrum 215. For example, the system may classify a first user input into a deterministic actions classification 225 and may classify a second user input into a semantic search, reasoning agent, or LLM classification 225. Though example classifications 225 are shown, any quantity of different classifications 225 are possible and are contemplated by the subject matter described herein. Further, additional classifications 225 besides those listed may also be considered and used.

In some examples, the classifying may be based on content of the user input. For example, in some cases, the user input may be a natural language prompt. In other cases, the user input may be a structured query or any other input that describes a user intent. For example, domain specific language or language associated with one or more classifications 225 may be employed to allow precise expression of user intent. For example, the user input may explicitly designate one or more data sources, runtime requirements, other contextual information, or any combination thereof along with text of a query. An example structured query is shown below.

query: {
“query_text”: “What are our sales broken
down by month for EMEA? Output one
monthly sale per line”,
“context”: {
“data-sources”: [
“private_vault_1”
“private_vault_2”
]},
“runtime-requirements”: {
“security-level”: “strict”,
“temperature”: 0
}
}

In some examples, the classifying may be based on a probability of mapping the request for data included in the user input to one or more data locations. For example, in the example structured query above, the data sources are explicitly specified, and, as such, the query may be associated with a high probability of mapping the request for data to a data location. In other examples, a user input may simply request information without explicitly specifying a data source, yet a data source may be implied in the request. For example, such a user input may read “Tell me the weather in Denver, Colorado right now.” Though no specific data source is specified, it may be inferred that a data source involving weather conditions may contain the requested data, and a (for example) medium probability of mapping the request to the data may be used and, as an example, a reasoning agent classification 225 may be selected. Yet other user inputs may involve a low probability of mapping the request to a data location, and an LLM classification 225 may be employed. Though examples of classifications 225 and mapping probabilities are discussed here, any combination of classifications and mapping probabilities are possible and contemplated by the subject matter herein.

In some examples, the system may classify the user input based on a bias or preference towards a deterministic classification 225. For example, the system may receive input specifying that a classification is to be biased towards the deterministic end of the deterministic-stochastic spectrum 215 in a case in which hallucination or errors in the use of one or more LLMs is to be reduced or eliminated. Such a bias or preference may be complete, in that the classification 225 of the user input is to be the most deterministic (or stochastic) possible, or the bias or preference may be partial and shift a classification 225 of the user input towards the deterministic or stochastic end of the deterministic-stochastic spectrum 215. In some examples, the system may rank different possible classifications 225 of the user input based upon a preference or bias. For example, the system may rank the classifications 225 in order of descending deterministic qualities, so that a top-ranked classification 225 is the most deterministic. Additionally, or alternatively, the system may rank the classifications 225 in order of descending stochastic qualities, so that a top-ranked classification 225 is the most stochastic.

In some examples, the system may select a classification 225 or classify the user input in a classification 225 based on a mapping between a data retrieval action that may be performed to access the data and one or more of the classifications 225. For example, a data retrieval action for a local, private database may be associated with a classification 225 of deterministic actions and a data retrieval action involving vector embedding may be associated with a classification 225 of semantic search. In some examples, one or more data retrieval actions may be preferred over one or more other retrieval actions, which may guide or influence the selection of a classification 225. Similarly, a data location may also influence the selection of a classification 225. For example, if a data location is unavailable or is determined to not have the relevant data, the classification 225 may be influenced in that a classification associated with such a data location may not be selected.

In some examples, the system may engage in one or more processing approaches 230 which may include one or more operations, tools, plugins, services, LLMs, queries, processes, or other elements that may be used to perform the operations described herein, including data retrieval, response generation, identification of data locations, extraction of information or data, one or more other operations described herein, or any combination thereof.

In some examples, the system may determine a data location or perform one or more other actions based on one or more keywords or explicit indications in the user input. For example, the data location may be determined to be a local data storage location if the user input includes one or more keywords that match keywords in a database of keywords associated with the local data storage location. Additionally, or alternatively, the system may determine the data location or perform one or more other actions based on metadata included in or associated with the user input. Additionally, or alternatively, the system may determine the data location or perform one or more other actions based on one or more rules (e.g., matching rules) that may apply to or are associated with one or more characteristics or elements of the user input. Additionally, or alternatively, the system may determine the data location or perform one or more other actions based on one or more mappings that may be created or generating based on one or more machine learning techniques. For example, a machine learning model may analyze past inputs, subsequent outputs, training data (e.g., labeled training data), explicit indications, or any combination thereof and may learn or predict one or more characteristics of user input that may be associated with one or more outputs (e.g., of an LLM or one or more elements of the system), actions to be performed (e.g., determining a data location), or any combination thereof. Additionally, or alternatively, an explicit indication of the data storage location may be indicated in the user input directly or in metadata of the user input. For example, in the example query shown below, the private_vault_1 and private_vault_2 are listed as data sources:

query: {
“query_text”: “What are our sales broken
down by month for EMEA? Output one
monthly sale per line”,
“context”: {
“data-sources”: [
“private_vault_1”
“private_vault_2”
]},
“runtime-requirements”: {
“security-level”: “strict”,
“temperature”: 0
}
}

In some examples, the system may retrieve the data from the one or more data locations. In some examples, one or more data locations may be associated with the classifications 225, and different data locations may be queried or searched based on the classification 225 of the user input. For example, for user input of a classification 225 of deterministic actions, a local or private data location of structured data may be used, whereas for a user input of a classification 225 of LLM, a commercial LLM (or alternatively, a publicly-accessible LLM, a locally-hosted LLM, a private LLM, or other LLM) may be queried. Again, while examples of classifications 225 and data locations are discussed here, any combination of classifications and data locations are possible and contemplated by the subject matter herein.

In some examples, the system may transmit an input to an LLM (e.g., a publicly-accessible LLM, a locally-hosted LLM, a private LLM, or other LLM). The system may transmit the input to the LLM, among other reasons, to obtain natural language output to present the response to the user input. For example, even if the system classifies a user input as a deterministic action classification 225 and queries a local or private database (or external data source) to retrieve data, the system may still transmit an input to an LLM to obtain an output from the LLM into which one or more aspects of the retrieved data may be placed (e.g., having the LLM format the data retrieved from a database into a natural-sounding or user-friendly response). In some examples, this LLM may be a publicly accessible LLM, a public LLM that has access restrictions (e.g., based on a token, key, password, or other tenant access control measure), or a private LLM (e.g., a self-hosted LLM, an LLM that is hosted in a private cloud platform, or a private LLM that is hosted on public servers).

In some examples, the system may present a response to the user input (e.g., to a user machine or via a user interface). The response may include an output of the LLM (e.g., that is based on the input transmitted to the LLM) and the retrieved data. In some examples, the retrieved data may be retrieved from the same LLM from which the output was received, or it may be received from a different data source or location (e.g., a local data location or a data location associated with an external service, tool, or plugin).

In some examples, the response to the user input may further include additional data analysis, data summary, or other processing results obtained from the LLM. For example, the response to the user input may include an indication of an anomaly, a data trend that is maintained, a data trend that is broken, a suggestion for action, a notification, or other output of which an LLM is capable. Such data analysis, data summary, or data other processing results may be based on natural language processing, statistical processing, or other processing. For example, if a query requests gross sales for last month, the LLM may format a response that not only includes the requested information (e.g., the gross sales for last month) but may also include an indication of a recent sales trend and an indication of whether the gross sales for last month follows or breaks the trend. Additionally, or alternatively, the response may include that the sales for last month are significantly different than sales from an earlier month or another comparison (e.g., based on a difference threshold). Additionally, or alternatively, the response may include other information or analysis (e.g., a summary or breakdown) of the sales that were made last month or other related information as determined by the LLM. Though particular examples are described here, any processing ability of an LLM may be used to produce an output that may be assembled into the response.

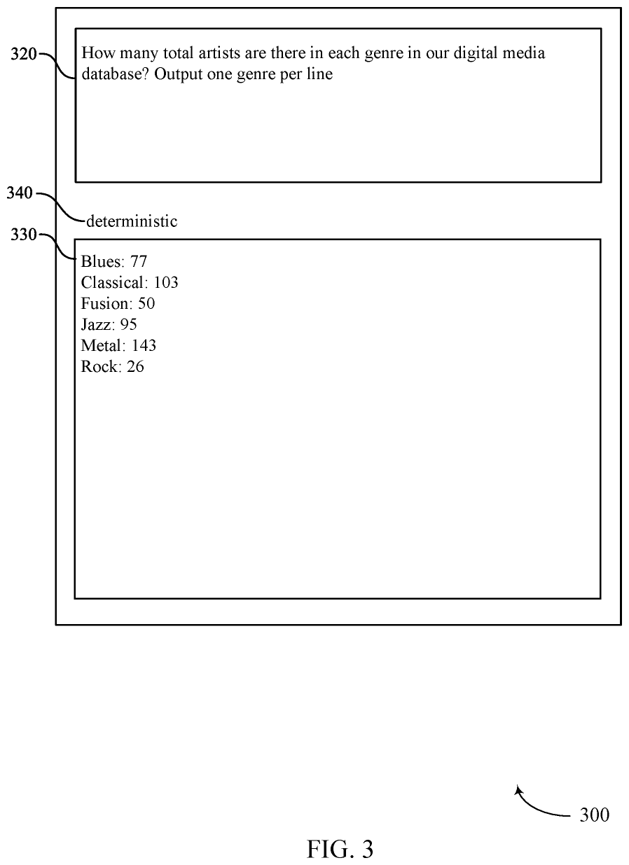

FIG. 3 shows an example of a user interface 300 that supports a large language model controller in accordance with examples as disclosed herein. The user interface 300 includes an input 320, an output 330, and a classification indication 340. In this example, the input 320 includes a question stating “How many total artists are there in each genre in our digital media database? Output one genre per line.” A system may respond with the output 330 that may include a listing of different genres in the digital media database, such as blues, classical, fusion, jazz, metal, and rock, with quantities of artists in each of these genres and one result per line, as designated in the input 320. The system may further generate and present the classification indication 340 that, in this example, is a deterministic classification indication 340. The classification indication may be determined or selected as described herein.

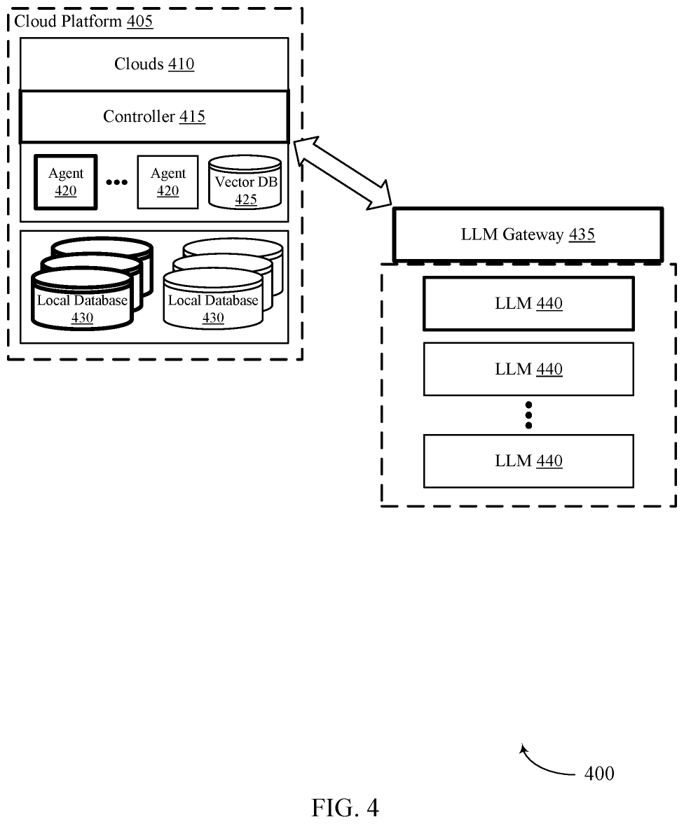

FIG. 4 shows an example of a system 400 that supports a large language model controller in accordance with examples as disclosed herein.

The system 400 may include a cloud platform 405 that may include one or more clouds 410 or processing entities. The controller 415 may manage operations with one or more LLMs 440 through the LLM gateway 435. The controller 415 may also manage operations with the one or more agents 420 of the cloud platform 405. The controller 415 may also manage operations with the vector database (DB) 425 of the cloud platform 405. The controller 415 may also manage operations with the one or more local databases 430 of the cloud platform 405. The controller 415 may communicate with one or more LLMs 440 via the LLM gateway 435 to manage operations that involve one or more LLMs 440. For example, the controller 415 may communicate with an LLM 440 to interpret the input 320, generate the output 330, or perform one or more other operations with the LLM 440. The controller 415 may communicate with or incorporate one or more LLMs that are locally hosted in or associated with the cloud platform 405.

For example, the controller 415 may receive the input 320 that includes the question regarding the quantity of artists in the digital media database. The controller 415 may communicate with one or more agents 420 of the cloud platform to retrieve the requested data about the quantities of artists for each genre from the local database 430 where such information may be stored. The controller 415 may further communicate with an LLM 440 via the LLM gateway 435 to generate some or all of the text or language of the output 330 into which the data retrieved from the local database 430 is included.

The controller 415 may, as described herein, classify the input 320 in one or more deterministic-stochastic spectrum classification. As part of the output 330 or alongside the output 330, the controller 415 may provide the classification indication 340 that may indicate the one or more deterministic-stochastic spectrum classifications into which the input 320 was classified in the process of producing the output 330.

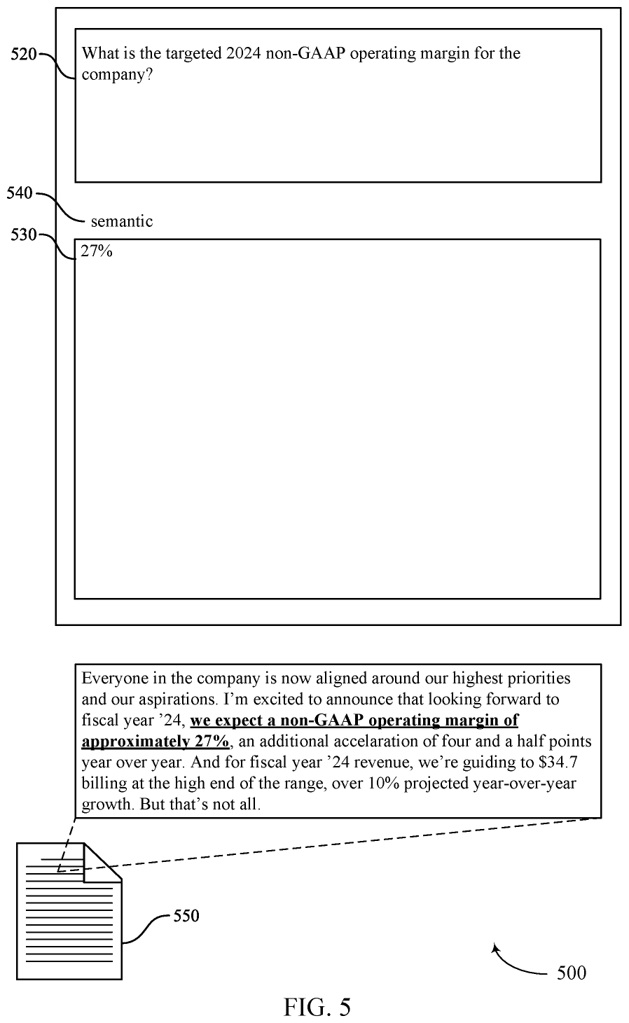

FIG. 5 shows an example of a user interface 500 that supports a large language model controller in accordance with examples as disclosed herein. The user interface 500 includes an input 520, an output 530, and a classification indication 540. In this example, the input 520 includes a question stating. “What is the targeted 2024 non-GAAP operating margin for the company?” A system may respond with the output 530 that may include the figure of 27%, as designated in the input 520 and in the source document 550. The system may access the source document 550 using one or more techniques as described herein to extract the requested information and present it in the output 530. The source document 550 may be stored in a local or private data location. In some cases, the system may use an output of an LLM to generate or format the output 530. The system may further generate and present the classification indication 540 that, in this example, is a semantic classification indication 540. The classification indication may be determined or selected as described herein.

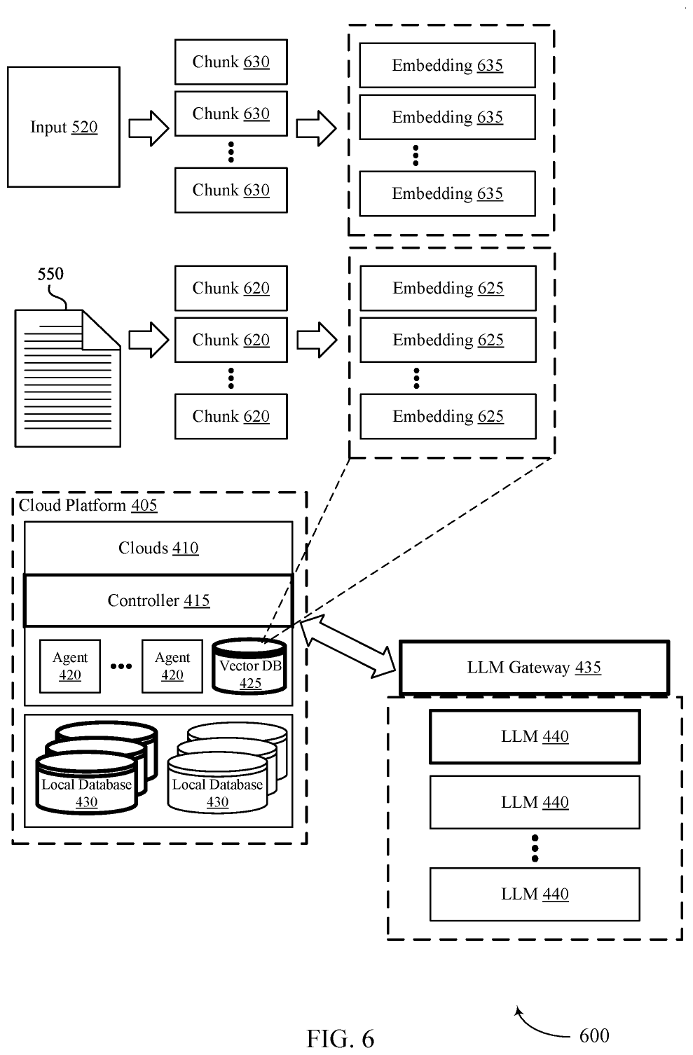

FIG. 6 shows an example of a system 600 that supports a large language model controller in accordance with examples as disclosed herein.

The system 600 may include a cloud platform 405 that may include one or more clouds 410 or processing entities. The controller 415 may manage operations with one or more LLMs 440 through the LLM gateway 435. The controller 415 may also manage operations with the one or more agents 420 of the cloud platform 405. The controller 415 may also manage operations with the vector DB 425 of the cloud platform 405. The controller 415 may also manage operations with the one or more local databases 430 of the cloud platform 405. The controller 415 may communicate with one or more LLMs 440 via the LLM gateway 435 to manage operations that involve one or more LLMs 440. For example, the controller 415 may communicate with an LLM 440 to interpret the input 520, generate the output 530, or perform one or more other operations with the LLM 440. The controller 415 may communicate with or incorporate one or more LLMs that are locally hosted in or associated with the cloud platform 405.

For example, the controller 415 may receive the input 520 that includes the question regarding the 2024 non-GAAP operating margin for the company. The controller 415 may communicate with one or more agents 420 of the cloud platform, the vector DB 425, or both to retrieve the requested data about the 2024 non-GAAP operating margin from the local database 430 where such information may be stored.

For example, the controller 415 may manage one or more embedded vector operations. For example, the controller 415 or other processing entity may analyze the data in the local database 430 (e.g., the source document 550) and select or generate chunks 620, one or more embeddings 625, or both. The controller 415 or other processing entity may also analyze the input 520 and select or generate chunks 630, one or more embeddings 635, or both. The controller 415 or other processing entity may perform one or more vector distance measurements or operations (e.g., a cosine distance or other measure/operation of vector distance) between the embeddings 625 and the embeddings 635 to determine one or more top documents (e.g., the source document 550). The controller 415 may then transmit a prompt to an LLM 440 (or locally-hosted LLM in the cloud platform 405) along with the one or more top documents and receive the output of the LLM 440 (or locally-hosted LLM in the cloud platform 405) that includes the output 530 that is presented to the user.

The controller 415 may, as described herein, classify the input 520 in one or more deterministic-stochastic spectrum classification. As part of the output 530 or alongside the output 530, the controller 415 may provide the classification indication 540 that may indicate the one or more deterministic-stochastic spectrum classifications into which the input 520 was classified in the process of producing the output 530.

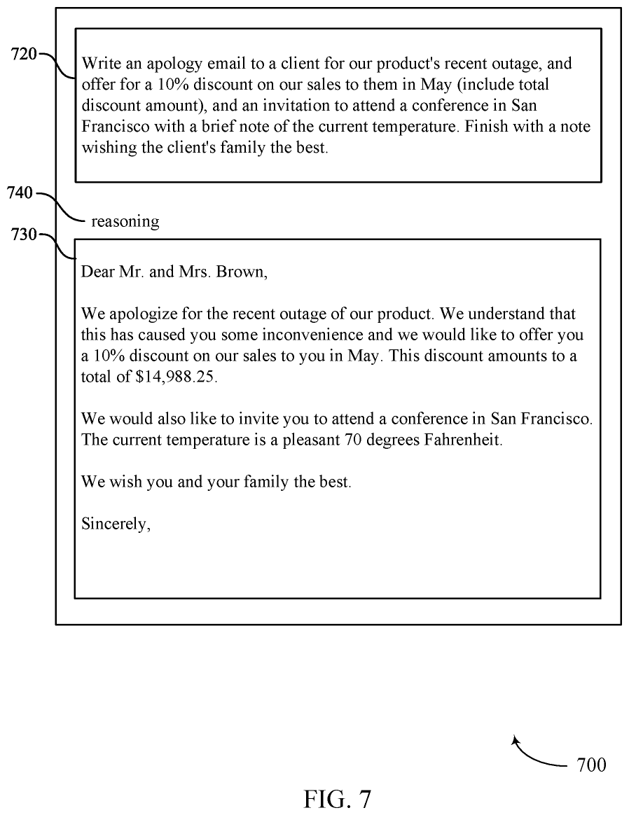

FIG. 7 shows an example of a user interface 700 that supports a large language model controller in accordance with examples as disclosed herein. The user interface 700 includes an input 720, an output 730, and a classification indication 740.

In this example, the input 720 includes a prompt stating “Write an apology email to a client for our product's recent outage, and offer for a 10% discount on our sales to them in May (include total discount amount), and an invitation to attend a conference in San Francisco with a brief note of the current temperature. Finish with a note wishing the client's family the best.” A system may respond with the output 730 that may include an apology email as designated in the input 720. The output 730 may include both data retrieved from private sources, local sources, one or more external services, tools, or plugins, language received from an LLM, or any combination thereof, as described herein. For example, the system may retrieve information about sales to the customer from a private data location, use an external computation service to calculate the 10% discount, use an external weather service to retrieve the current temperature in San Francisco, and query the LLM to generate the text of the output 730. The system may further generate and present the classification indication 740) that, in this example, is a reasoning classification indication 740. The classification indication may be determined or selected as described herein.

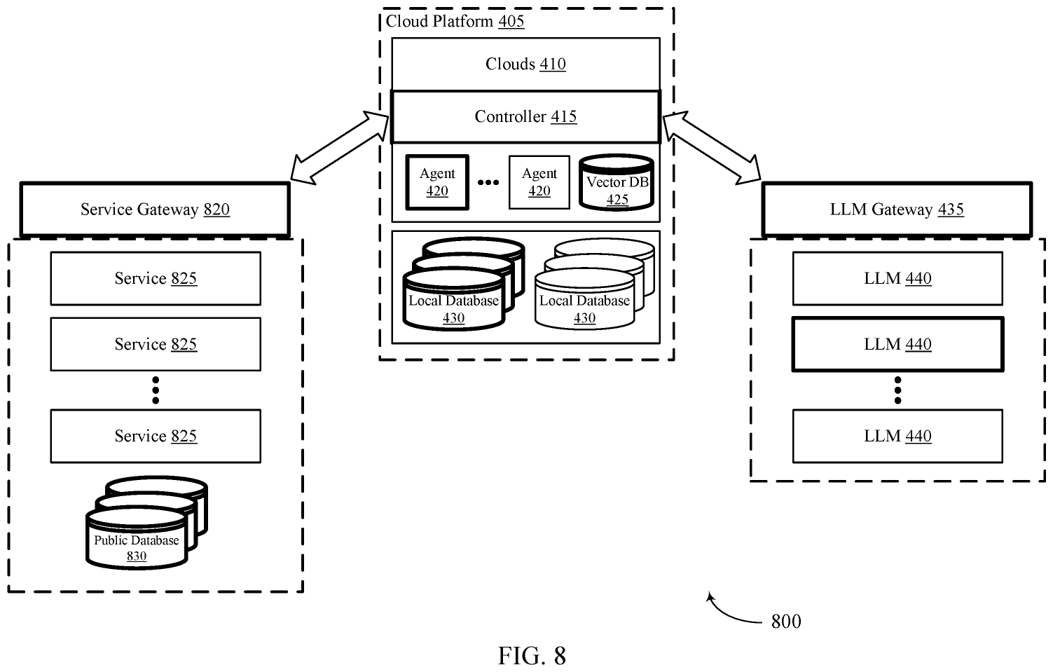

FIG. 8 shows an example of a system 800 that supports a large language model controller in accordance with examples as disclosed herein.

The system 800 may include a cloud platform 405 that may include one or more clouds 410 or processing entities. The controller 415 may manage operations with one or more LLMs 440) through the LLM gateway 435. The controller 415 may also manage operations with the one or more agents 420 of the cloud platform 405. The controller 415 may also manage operations with the vector DB 425 of the cloud platform 405. The controller 415 may also manage operations with the one or more local databases 430 of the cloud platform 405. The controller 415 may communicate with one or more LLMs 440 via the LLM gateway 435 to manage operations that involve one or more LLMs 440. For example, the controller 415 may communicate with an LLM 440 to interpret the input 720, generate the output 730, or perform one or more other operations with the LLM 440. The controller 415 may communicate with one or more external services 825 (which may also be referred to as tools or plugins) via the service gateway 820. The services 825 may include one or more services from which data may be retrieved, such as a structured data service, a tenant search service, a semantic search service, a segmentation service, a messaging service, an email service, a prediction service, a territory management services, a sales service, a mapping service, a document service, a commerce service, a weather service, an information lookup service, a search engine, a computation service, a social media service, one or more data connectors, or any combination thereof. For example, the controller 415 may select one or more of the services 825 that it deems to be applicable to responding to the user input and may select multiple services 825 that may be used in combination to sufficiently respond to the user input (e.g., by collecting information or otherwise utilizing the services 825). For example, the controller 415 may retrieve information from a structured data service, a semantic search service by transmitting one or more queries to a service 825 and may receive one or more responses to the one or more queries. In some examples, the controller 415 may transmit a request, a query, information, or any combination thereof to a service 825 to employ the service 825 to perform one or more operations. For example, the controller 845 may transmit text and an email address for the email service to send an email including the text to the email address. One or more of the services 825 may be associated with one or more public, access controlled, or private databases 830 that may store the data that is to be retrieved from one or more of the services 825. The controller 415 may communicate with or incorporate one or more LLMs that are locally hosted in or associated with the cloud platform 405.

For example, the controller 415 may receive the input 720 that includes the prompt to write the apology email. The input 720 includes various elements of data that are to be retrieved, including apology email text, an amount of sales in May, a 10% calculation of the amount of sales, and a current temperature in San Francisco. The controller 415 may determine one or more data sources from which these elements of data are to be retrieved. For example, the controller 415 may determine that the apology email text is to be generated by and retrieved from the LLM 440, the amount of sales is to be retrieved from the local database 430, the 10% calculation of the amount of sales in May is to be calculated by a first service 825 (e.g., a computation service), and the current temperature in San Francisco is to be retrieved from a second service 825 (e.g., a weather service). In some examples, the controller 415 may perform a vector embedding and comparison process involving one or more elements of the input 720 and one or more elements of descriptions of the services 825 to identify which services 825 would be appropriate to use to retrieve the elements of data used to generate the output 730.

The controller 415 may then orchestrate the various data retrievals, processing tasks, other operations, or any combination thereof used to retrieve the various elements of the output 730 and assemble the output 730. For example, the controller 415 may retrieve the amount of sales in May, a 10% calculation of the amount of sales, and a current temperature in San Francisco, and may transmit this data to an LLM 440 (or a locally hosted LLM in the cloud platform 405) and prompt the LLM 440 (or the locally hosted LLM in the cloud platform 405) to use the data and create the apology email.

Additionally, or alternatively, the controller 415 may prompt the LLM 440 to create the apology email with placeholders into which the controller 415 may insert the retrieved data (e.g., to maintain data security by not transmitting the retrieved data outside of the cloud platform 405) and transmit the output 730. For example, if a data item is to remain confidential and should not be transmitted to the LLM for processing, a substitute identifier that describes a similar data item may be used in place of a true identifier of the data item. For example, if a company name of “ACME Cola” is to remain private and should not be sent to the LLM, then “ACME Cola” may be tagged for replacement with a substitute identifier, such as “Mountain Cola.” In some examples, the substitute identifier may be a similar type of identifier that might provoke a similar response from the LLM without disclosing the private data item. In some examples, the data items to be replaced may be identified through regular expression matching. In addition to or as an alternative to such tagging approaches, named entity recognition approaches may be used. For example, named entity recognition processing may recognize elements (e.g., proper nouns) in a search query and substitute identifiers may then be provided or generated for transmission to the LLM.

The controller 415 may communicate with one or more agents 420 of the cloud platform to retrieve the requested data about the quantities of artists for each genre from the local database 430 where such information may be stored. The controller 415 may further communicate with an LLM 440 via the LLM gateway 435 to generate some or all of the text or language of the output 730 into which the data retrieved from the local database 430 is included.

The controller 415 may, as described herein, classify the input 720 in one or more deterministic-stochastic spectrum classification. As part of the output 730 or alongside the output 730, the controller 415 may provide the classification indication 740 that may indicate the one or more deterministic-stochastic spectrum classifications into which the input 720 was classified in the process of producing the output 730.

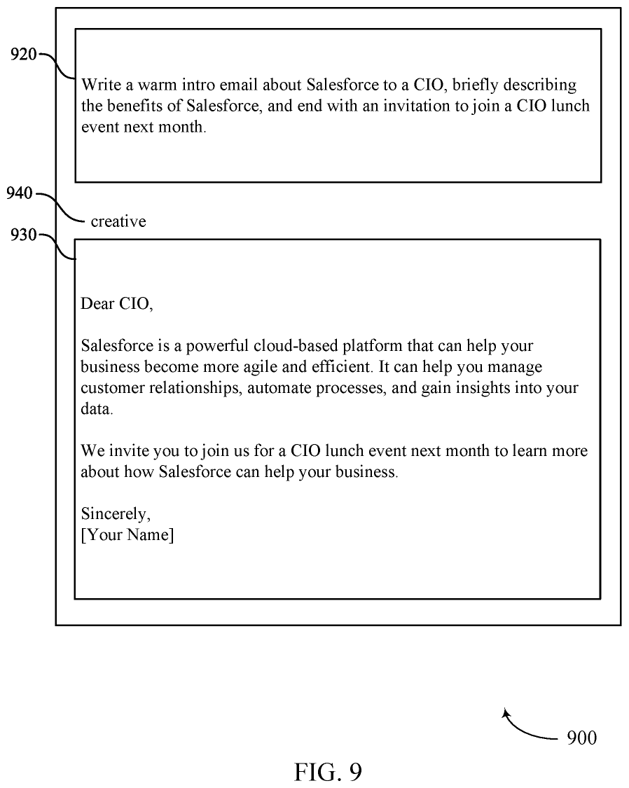

FIG. 9 shows an example of a user interface 900 that supports a large language model controller in accordance with examples as disclosed herein. The user interface 900 includes an input 920, an output 930, and a classification indication 940. In this example, the input 920 includes a prompt stating “Write a warm intro email about Salesforce to a CIO, briefly describing the benefits of Salesforce, and end with an invitation to join a CIO lunch event next month.” A system may respond with the output 930 that may include an introductory email as designated in the input 920. The output 930 may include language received from an LLM without other data from other sources, as the input 920 indicated a purely creative or stochastic prompt, which may be determined as described herein. The system may further generate and present the classification indication 940 that, in this example, is a creative classification indication 940. The classification indication may be determined or selected as described herein.

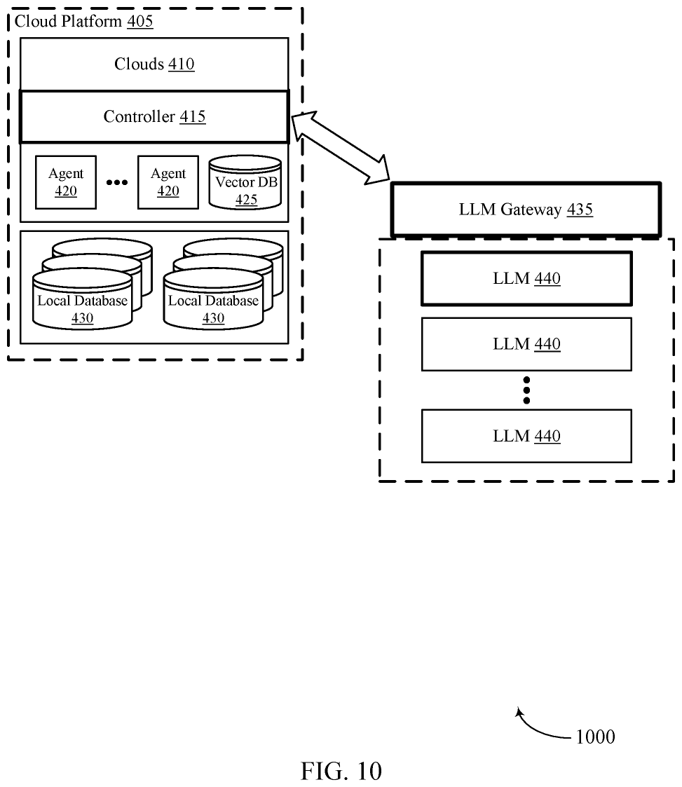

FIG. 10 shows an example of a system 1000 that supports a large language model controller in accordance with examples as disclosed herein.

The system 1000 may include a cloud platform 405 that may include one or more clouds 410 or processing entities. The controller 415 may manage operations with one or more LLMs 440 through the LLM gateway 435. The controller 415 may also manage operations with the one or more agents 420 of the cloud platform 405. The controller 415 may also manage operations with the vector DB 425 of the cloud platform 405. The controller 415 may also manage operations with the one or more local databases 430 of the cloud platform 405. The controller 415 may communicate with one or more LLMs 440 via the LLM gateway 435 to manage operations that involve one or more LLMs 440. For example, the controller 415 may communicate with an LLM 440 to interpret the input 920, generate the output 930, or perform one or more other operations with the LLM 440. The controller 415 may communicate with or incorporate one or more LLMs that are locally hosted in or associated with the cloud platform 405.

For example, the controller 415 may receive the input 920 that includes the prompt to generate the introductory email to the CIO. As such a task may not involve data retrieval from any storage locations, the controller 415 may simply communicate with an LLM 440 via the LLM gateway 435 to generate some or all of the text or language of the output 930 into which the data retrieved from the local database 430 is included. For example, the LLM 440 may generate the output 930 that include the introductory email to the CIO.

The controller 415 may, as described herein, classify the input 920 in one or more deterministic-stochastic spectrum classification. As part of the output 930 or alongside the output 930, the controller 415 may provide the classification indication 940 that may indicate the one or more deterministic-stochastic spectrum classifications into which the input 920 was classified in the process of producing the output 930.

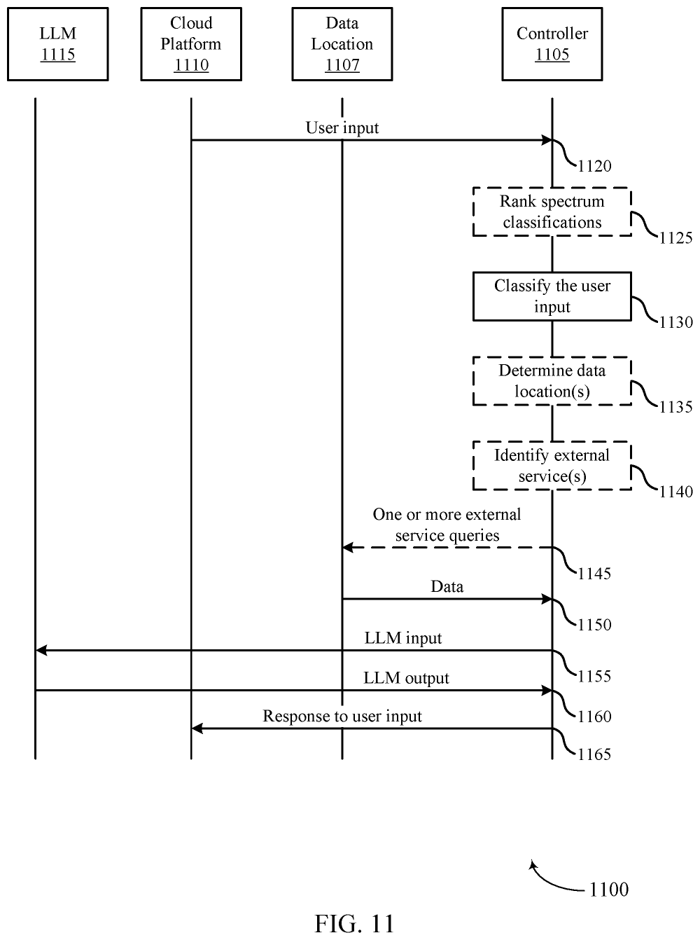

FIG. 11 shows an example of a process flow 1100 that supports a large language model controller in accordance with examples as disclosed herein. The process flow 1100 may implement various aspects of the present disclosure described herein. The elements described in the process flow 1100 (e.g., controller 1105, data location 1107, cloud platform 1110, and large language model 1115) may be examples of similarly named elements described herein.

In the following description of the process flow 1100, the operations between the various entities or elements may be performed in different orders or at different times. Some operations may also be left out of the process flow 1100, or other operations may be added. Although the various entities or elements are shown performing the operations of the process flow 1100, some aspects of some operations may also be performed by other entities or elements of the process flow 1100 or by entities or elements that are not depicted in the process flow, or any combination thereof.

At 1120, the controller 1105 may receive, via a cloud-based platform, user input that may include at least one request for data.

At 1125, the controller 1105 may rank one or more of the plurality of deterministic-stochastic spectrum classifications based on a classification bias towards a deterministic classification and classifying the user input into the first deterministic-stochastic spectrum classification is based on the ranking.

At 1130, the controller 1105 may classify the user input into a first of a plurality of deterministic-stochastic spectrum classifications based on the user input and a probability of mapping the at least one request for data to at least one data location 1107. In some examples, the at least one data location 1107 may include one or more data locations 1107 associated with the one or more external services. In some examples, the controller 1105 may select the first deterministic-stochastic spectrum classification based on a mapping between one or more data retrieval actions associated with the data and one or more of the plurality of deterministic-stochastic spectrum classifications, the mapping based on a specificity measure of the user input. In some examples, the controller 1105 may classify the user input into the first deterministic-stochastic spectrum classification based on a classification bias towards a deterministic classification. In some examples, the controller 1105 may select the first deterministic-stochastic spectrum classification based on the at least one data location 1107.

At 1135, the controller 1105 may determine the at least one data location 1107 based on metadata associated with the user input, an explicit action indication in the user input, a matching rule, a machine-learning derived match, a keyword match between one or more tokens of the user input and one or more entries in a table of tokens that are associated with the at least one data location 1107, or any combination thereof.

At 1140, the controller 1105 may identify, based on the user input, one or more external services that are external to the cloud-based platform and that are capable of providing the data. In some examples, the controller 1105, to identify the one or more external services, may perform a vector distance calculation between one or more first vectors associated with a vector embedding of the user input and a plurality of second vectors associated with one or more vector embeddings of one or more descriptions of a plurality of external services that comprise the one or more external services to identify the one or more external services based on one or more second vectors of the plurality of second vectors that are associated with the one or more external services and satisfy a vector distance threshold.

At 1145, the controller 1105 may transmit one or more queries to the one or more external services. In some examples, the controller 1105 may transmit one or more queries that request the data to the one or more external services.

At 1150, the controller 1105 may retrieve the data from the at least one data location 1107 and based on the first deterministic-stochastic spectrum classification. In some examples, the controller 1105 may receive the data from the one or more external services. In some examples, retrieving the data may include performing a vector distance calculation between one or more first vectors associated with a vector embedding of the user input and a plurality of second vectors associated with a plurality of vector embeddings of the at least one data location 1107 to identify the data based on one or more second vectors of the plurality of second vectors that are associated with the data and satisfy a vector distance threshold, as well as retrieving the data that is associated with the one or more second vectors of the plurality of second vectors. In some examples, the controller 1105 may retrieve the data from a structured data service, a tenant search service, a semantic search service, a segmentation service, a messaging service, an email service, a prediction service, a territory management services, a sales service, a mapping service, a document service, a commerce service, one or more data connectors, or any combination thereof.

At 1155, the controller 1105 may transmit, based on the first deterministic-stochastic spectrum classification and the user input, an input to a large language model 1115. In some examples, the large language model 1115 is a publicly accessible large language model 1115. In some examples, the large language model 1115 is a private large language model 1115 stored within the cloud-based platform.

At 1160, the controller 1105 may receive an output of the large language model 1115.

At 1165, the controller 1105 may present a response to the user input, where the response is based on a combination of an output of the large language model 1115 and the data retrieved from the at least one data location 1107. In some examples, the controller 1105 may present an indication of the first deterministic-stochastic spectrum classification with the response.

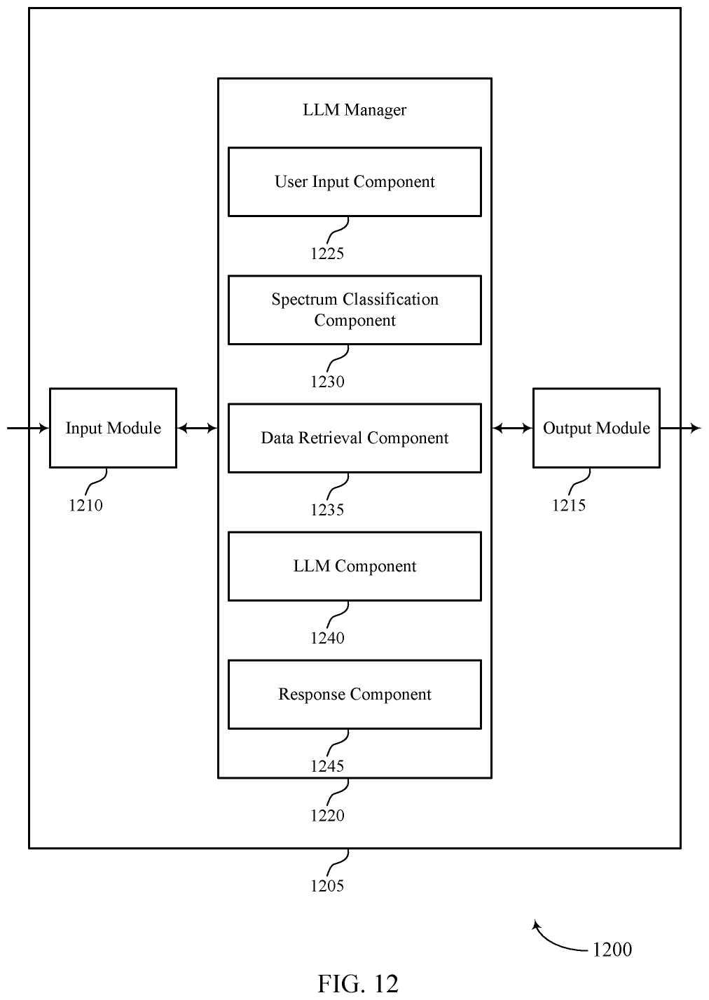

FIG. 12 shows a block diagram 1200 of a device 1205 that supports a large language model controller in accordance with examples as disclosed herein. The device 1205 may include an input module 1210, an output module 1215, and an LLM manager 1220. The device 1205, or one or more of more components of the device 1205 (e.g., the input module 1210, the output module 1215, and the LLM manager 1220), may include at least one processor, which may be coupled with at least one memory, to support the described techniques. Each of these components may be in communication with one another (e.g., via one or more buses).

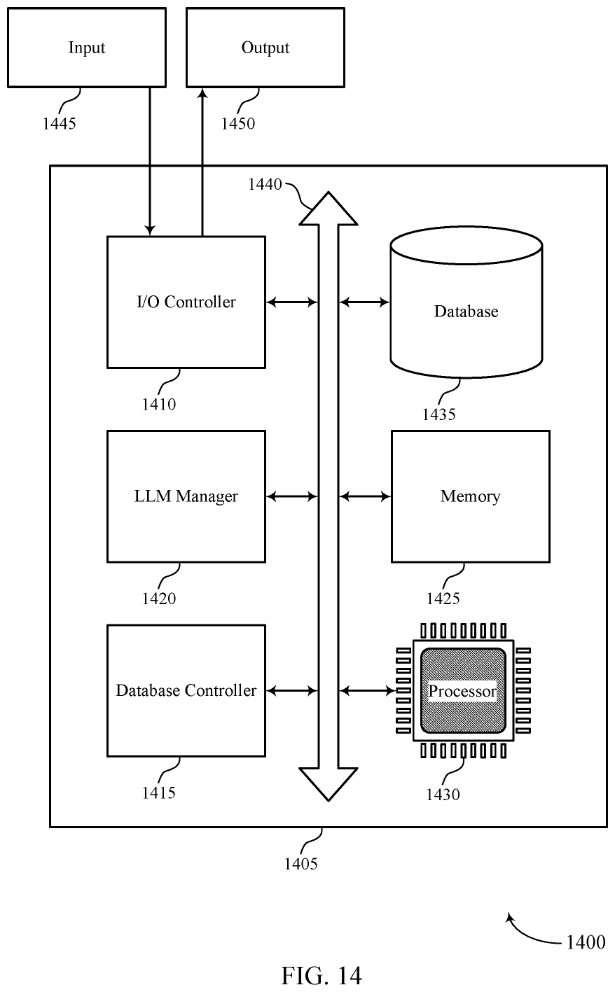

The input module 1210 may manage input signals for the device 1205. For example, the input module 1210 may identify input signals based on an interaction with a modem, a keyboard, a mouse, a touchscreen, or a similar device. These input signals may be associated with user input or processing at other components or devices. In some cases, the input module 1210 may utilize an operating system such as iOS®, ANDROID®, MS-DOS®, MS-WINDOWS®, OS/2®, UNIX®, LINUX®, or another known operating system to handle input signals. The input module 1210 may send aspects of these input signals to other components of the device 1205 for processing. For example, the input module 1210 may transmit input signals to the LLM manager 1220 to support large language model controller. In some cases, the input module 1210 may be a component of an I/O controller 1410 as described with reference to FIG. 14.

The output module 1215 may manage output signals for the device 1205. For example, the output module 1215 may receive signals from other components of the device 1205, such as the LLM manager 1220, and may transmit these signals to other components or devices. In some examples, the output module 1215 may transmit output signals for display in a user interface, for storage in a database or data store, for further processing at a server or server cluster, or for any other processes at any quantity of devices or systems. In some cases, the output module 1215 may be a component of an I/O controller 1410 as described with reference to FIG. 14.

For example, the LLM manager 1220 may include a user input component 1225, a spectrum classification component 1230, a data retrieval component 1235, an LLM component 1240, a response component 1245, or any combination thereof. In some examples, the LLM manager 1220, or various components thereof, may be configured to perform various operations (e.g., receiving, monitoring, transmitting) using or otherwise in cooperation with the input module 1210, the output module 1215, or both. For example, the LLM manager 1220 may receive information from the input module 1210, send information to the output module 1215, or be integrated in combination with the input module 1210, the output module 1215, or both to receive information, transmit information, or perform various other operations as described herein.

The LLM manager 1220 may support data processing in accordance with examples as disclosed herein. The user input component 1225 may be configured to support receiving, via a cloud-based platform, user input including at least one request for data. The spectrum classification component 1230 may be configured to support classifying the user input into a first of a set of multiple deterministic-stochastic spectrum classifications based on the user input and a probability of mapping the at least one request for data to at least one data location. The data retrieval component 1235 may be configured to support retrieving the data from the at least one data location and based on the first deterministic-stochastic spectrum classification. The LLM component 1240 may be configured to support transmitting, based on the first deterministic-stochastic spectrum classification and the user input, an input to a large language model. The response component 1245 may be configured to support presenting a response to the user input, where the response is based on a combination of an output of the large language model and the data retrieved from the at least one data location.

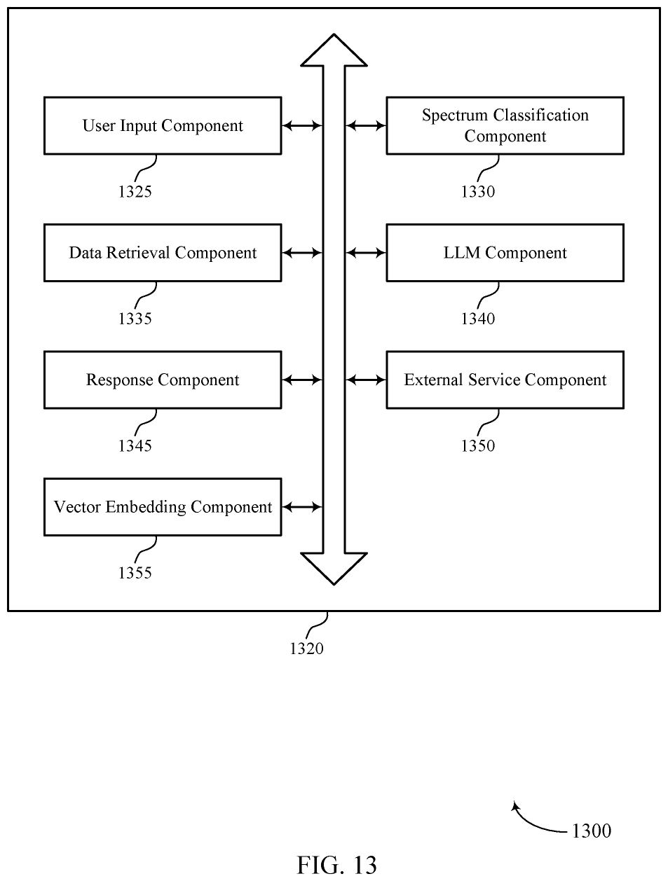

FIG. 13 shows a block diagram 1300 of an LLM manager 1320 that supports a large language model controller in accordance with examples as disclosed herein. The LLM manager 1320 may be an example of aspects of an LLM manager or an LLM manager 1220, or both, as described herein. The LLM manager 1320, or various components thereof, may be an example of means for performing various aspects of large language model controller as described herein. For example, the LLM manager 1320 may include a user input component 1325, a spectrum classification component 1330, a data retrieval component 1335, an LLM component 1340, a response component 1345, an external service component 1350, a vector embedding component 1355, or any combination thereof. Each of these components, or components of subcomponents thereof (e.g., one or more processors, one or more memories), may communicate, directly or indirectly, with one another (e.g., via one or more buses).

The LLM manager 1320 may support data processing in accordance with examples as disclosed herein. The user input component 1325 may be configured to support receiving, via a cloud-based platform, user input including at least one request for data. The spectrum classification component 1330 may be configured to support classifying the user input into a first of a set of multiple deterministic-stochastic spectrum classifications based on the user input and a probability of mapping the at least one request for data to at least one data location. The data retrieval component 1335 may be configured to support retrieving the data from the at least one data location and based on the first deterministic-stochastic spectrum classification. The LLM component 1340 may be configured to support transmitting, based on the first deterministic-stochastic spectrum classification and the user input, an input to a large language model. The response component 1345 may be configured to support presenting a response to the user input, where the response is based on a combination of an output of the large language model and the data retrieved from the at least one data location.

In some examples, the large language model is a publicly accessible large language model.

In some examples, the large language model is a private large language model stored within the cloud-based platform.

In some examples, the response component 1345 may be configured to support presenting an indication of the first deterministic-stochastic spectrum classification with the response.

In some examples, to support retrieving the data, the external service component 1350 may be configured to support identifying, based on the user input, one or more external services that are external to the cloud-based platform and that are capable of providing the data. In some examples, to support retrieving the data, the external service component 1350 may be configured to support transmitting one or more queries to the one or more external services. In some examples, to support retrieving the data, the data retrieval component 1335 may be configured to support receiving the data from the one or more external services. In some examples, to support retrieving the data, the data retrieval component 1335 may be configured to support where the at least one data location includes one or more data locations associated with the one or more external services.

In some examples, identifying the one or more external services includes performing a vector distance calculation between one or more first vectors associated with a vector embedding of the user input and a set of multiple second vectors associated with one or more vector embeddings of one or more descriptions of a set of multiple external services that include the one or more external services to identify the one or more external services based on one or more second vectors of the set of multiple second vectors that are associated with the one or more external services and satisfy a vector distance threshold. In some examples, receiving the data from the one or more external services includes receiving one or more responses to the one or more queries that include the data that is associated with the one or more second vectors of the set of multiple second vectors.

In some examples, to support retrieving the data, the vector embedding component 1355 may be configured to support performing a vector distance calculation between one or more first vectors associated with a vector embedding of the user input and a set of multiple second vectors associated with a set of multiple vector embeddings of the at least one data location to identify the data based on one or more second vectors of the set of multiple second vectors that are associated with the data and satisfy a vector distance threshold. In some examples, to support retrieving the data, the data retrieval component 1335 may be configured to support retrieving the data that is associated with the one or more second vectors of the set of multiple second vectors.

In some examples, the data retrieval component 1335 may be configured to support determining the at least one data location based on metadata associated with the user input, an explicit action indication in the user input, a matching rule, a machine-learning derived match, a keyword match between one or more tokens of the user input and one or more entries in a table of tokens that are associated with the at least one data location, or any combination thereof.

In some examples, the data retrieval component 1335 may be configured to support selecting the first deterministic-stochastic spectrum classification based on a mapping between one or more data retrieval actions associated with the data and one or more of the set of multiple deterministic-stochastic spectrum classifications, the mapping based on a specificity measure of the user input.

In some examples, the spectrum classification component 1330 may be configured to support classifying the user input into the first deterministic-stochastic spectrum classification based on a classification bias towards a deterministic classification.

In some examples, the spectrum classification component 1330 may be configured to support ranking one or more of the set of multiple deterministic-stochastic spectrum classifications based on a classification bias towards a deterministic classification, where classifying the user input into the first deterministic-stochastic spectrum classification is based on the ranking.

In some examples, the spectrum classification component 1330 may be configured to support selecting the first deterministic-stochastic spectrum classification based on the at least one data location.

In some examples, the data retrieval component 1335 may be configured to support retrieving the data from a structured data service, a tenant search service, a semantic search service, a segmentation service, a messaging service, an email service, a prediction service, a territory management services, a sales service, a mapping service, a document service, a commerce service, one or more data connectors, or any combination thereof.

FIG. 14 shows a diagram of a system 1400 including a device 1405 that supports a large language model controller in accordance with examples as disclosed herein. The device 1405 may be an example of or include the components of a device 1205 as described herein. The device 1405 may include components for bi-directional data communications including components for transmitting and receiving communications, such as an LLM manager 1420, an I/O controller 1410, a database controller 1415, at least one memory 1425, at least one processor 1430, and a database 1435. These components may be in electronic communication or otherwise coupled (e.g., operatively, communicatively, functionally, electronically, electrically) via one or more buses (e.g., a bus 1440).

The I/O controller 1410 may manage input signals 1445 and output signals 1450 for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. In other cases, the I/O controller 1410 may represent or interact with a modem, a keyboard, a mouse, a touchscreen, or a similar device. In some cases, the I/O controller 1410 may be implemented as part of a processor 1430. In some examples, a user may interact with the device 1405 via the I/O controller 1410 or via hardware components controlled by the I/O controller 1410.

The database controller 1415 may manage data storage and processing in a database 1435. In some cases, a user may interact with the database controller 1415. In other cases, the database controller 1415 may operate automatically without user interaction. The database 1435 may be an example of a single database, a distributed database, multiple distributed databases, a data store, a data lake, or an emergency backup database.

Memory 1425 may include random-access memory (RAM) and ROM. The memory 1425 may store computer-readable, computer-executable software including instructions that, when executed, cause at least one processor 1430 to perform various functions described herein. In some cases, the memory 1425 may contain, among other things, a BIOS which may control basic hardware or software operation such as the interaction with peripheral components or devices. The memory 1425 may be an example of a single memory or multiple memories. For example, the device 1405 may include one or more memories 1425.

The processor 1430 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1430 may be configured to operate a memory array using a memory controller. In other cases, a memory controller may be integrated into the processor 1430. The processor 1430 may be configured to execute computer-readable instructions stored in at least one memory 1425 to perform various functions (e.g., functions or tasks supporting large language model controller). The processor 1430 may be an example of a single processor or multiple processors. For example, the device 1405 may include one or more processors 1430.

The LLM manager 1420 may support data processing in accordance with examples as disclosed herein. For example, the LLM manager 1420 may be configured to support receiving, via a cloud-based platform, user input including at least one request for data. The LLM manager 1420 may be configured to support classifying the user input into a first of a set of multiple deterministic-stochastic spectrum classifications based on the user input and a probability of mapping the at least one request for data to at least one data location. The LLM manager 1420 may be configured to support retrieving the data from the at least one data location and based on the first deterministic-stochastic spectrum classification. The LLM manager 1420 may be configured to support transmitting, based on the first deterministic-stochastic spectrum classification and the user input, an input to a large language model. The LLM manager 1420 may be configured to support presenting a response to the user input, where the response is based on a combination of an output of the large language model and the data retrieved from the at least one data location.

By including or configuring the LLM manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

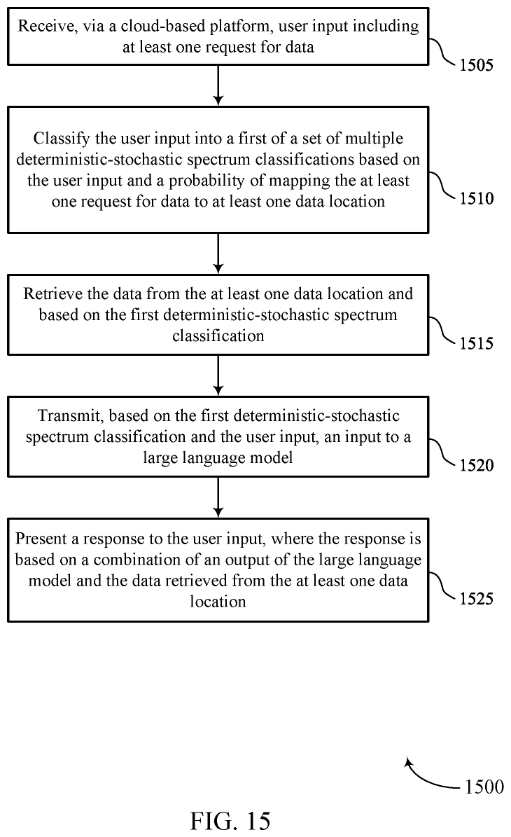

FIG. 15 shows a flowchart illustrating a method 1500 that supports a large language model controller in accordance with examples as disclosed herein. The operations of the method 1500 may be implemented by an application server or its components as described herein. For example, the operations of the method 1500 may be performed by an application server as described with reference to FIGS. 1 through 14. In some examples, an application server may execute a set of instructions to control the functional elements of the application server to perform the described functions. Additionally, or alternatively, the application server may perform aspects of the described functions using special-purpose hardware.

At 1505, the method may include receiving, via a cloud-based platform, user input including at least one request for data. The operations of block 1505 may be performed in accordance with examples as disclosed herein. In some examples, aspects of the operations of 1505 may be performed by a user input component 1325 as described with reference to FIG. 13.

At 1510, the method may include classifying the user input into a first of a set of multiple deterministic-stochastic spectrum classifications based on the user input and a probability of mapping the at least one request for data to at least one data location. The operations of block 1510 may be performed in accordance with examples as disclosed herein. In some examples, aspects of the operations of 1510 may be performed by a spectrum classification component 1330 as described with reference to FIG. 13.

At 1515, the method may include retrieving the data from the at least one data location and based on the first deterministic-stochastic spectrum classification. The operations of block 1515 may be performed in accordance with examples as disclosed herein. In some examples, aspects of the operations of 1515 may be performed by a data retrieval component 1335 as described with reference to FIG. 13.

At 1520, the method may include transmitting, based on the first deterministic-stochastic spectrum classification and the user input, an input to a large language model. The operations of block 1520 may be performed in accordance with examples as disclosed herein. In some examples, aspects of the operations of 1520 may be performed by an LLM component 1340 as described with reference to FIG. 13.

At 1525, the method may include presenting a response to the user input, where the response is based on a combination of an output of the large language model and the data retrieved from the at least one data location. The operations of block 1525 may be performed in accordance with examples as disclosed herein. In some examples, aspects of the operations of 1525 may be performed by a response component 1345 as described with reference to FIG. 13.

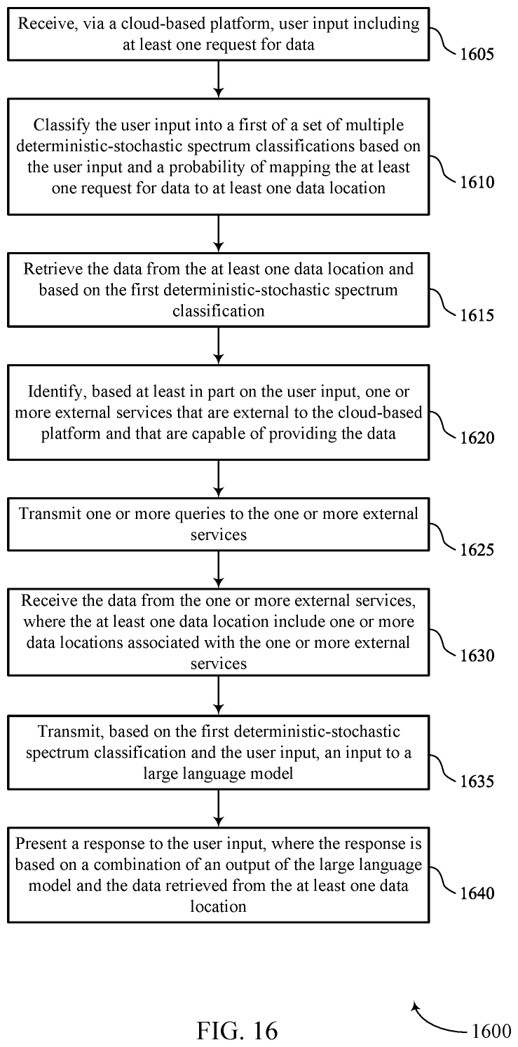

FIG. 16 shows a flowchart illustrating a method 1600 that supports a large language model controller in accordance with examples as disclosed herein. The operations of the method 1600 may be implemented by an application server or its components as described herein. For example, the operations of the method 1600 may be performed by an application server as described with reference to FIGS. 1 through 14. In some examples, an application server may execute a set of instructions to control the functional elements of the application server to perform the described functions. Additionally, or alternatively, the application server may perform aspects of the described functions using special-purpose hardware.

At 1605, the method may include receiving, via a cloud-based platform, user input including at least one request for data. The operations of block 1605 may be performed in accordance with examples as disclosed herein. In some examples, aspects of the operations of 1605 may be performed by a user input component 1325 as described with reference to FIG. 13.

At 1610, the method may include classifying the user input into a first of a set of multiple deterministic-stochastic spectrum classifications based on the user input and a probability of mapping the at least one request for data to at least one data location. The operations of block 1610 may be performed in accordance with examples as disclosed herein. In some examples, aspects of the operations of 1610 may be performed by a spectrum classification component 1330 as described with reference to FIG. 13.

At 1615, the method may include retrieving the data from the at least one data location and based on the first deterministic-stochastic spectrum classification. The operations of block 1615 may be performed in accordance with examples as disclosed herein. In some examples, aspects of the operations of 1615 may be performed by a data retrieval component 1335 as described with reference to FIG. 13.

At 1620, the method may include identifying, based on the user input, one or more external services that are external to the cloud-based platform and that are capable of providing the data. The operations of block 1620 may be performed in accordance with examples as disclosed herein. In some examples, aspects of the operations of 1620 may be performed by an external service component 1350 as described with reference to FIG. 13.

At 1625, the method may include transmitting one or more queries to the one or more external services. The operations of block 1625 may be performed in accordance with examples as disclosed herein. In some examples, aspects of the operations of 1625 may be performed by an external service component 1350 as described with reference to FIG. 13.

At 1630, the method may include receiving the data from the one or more external services. In some examples, the at least one data location includes one or more data locations associated with the one or more external services. The operations of block 1630 may be performed in accordance with examples as disclosed herein. In some examples, aspects of the operations of 1630 may be performed by a data retrieval component 1335 as described with reference to FIG. 13.

At 1635, the method may include transmitting, based on the first deterministic-stochastic spectrum classification and the user input, an input to a large language model. The operations of block 1635 may be performed in accordance with examples as disclosed herein. In some examples, aspects of the operations of 1635 may be performed by an LLM component 1340 as described with reference to FIG. 13.

At 1640, the method may include presenting a response to the user input, where the response is based on a combination of an output of the large language model and the data retrieved from the at least one data location. The operations of block 1640 may be performed in accordance with examples as disclosed herein. In some examples, aspects of the operations of 1640 may be performed by a response component 1345 as described with reference to FIG. 13.

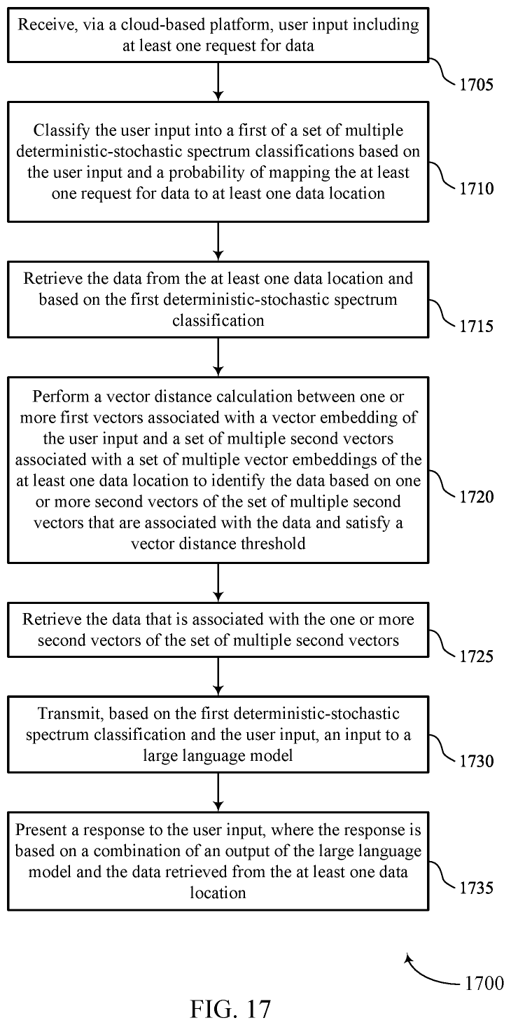

FIG. 17 shows a flowchart illustrating a method 1700 that supports a large language model controller in accordance with examples as disclosed herein. The operations of the method 1700 may be implemented by an application server or its components as described herein. For example, the operations of the method 1700 may be performed by an application server as described with reference to FIGS. 1 through 14. In some examples, an application server may execute a set of instructions to control the functional elements of the application server to perform the described functions. Additionally, or alternatively, the application server may perform aspects of the described functions using special-purpose hardware.

At 1705, the method may include receiving, via a cloud-based platform, user input including at least one request for data. The operations of block 1705 may be performed in accordance with examples as disclosed herein. In some examples, aspects of the operations of 1705 may be performed by a user input component 1325 as described with reference to FIG. 13.

At 1710, the method may include classifying the user input into a first of a set of multiple deterministic-stochastic spectrum classifications based on the user input and a probability of mapping the at least one request for data to at least one data location. The operations of block 1710 may be performed in accordance with examples as disclosed herein. In some examples, aspects of the operations of 1710 may be performed by a spectrum classification component 1330 as described with reference to FIG. 13.

At 1715, the method may include retrieving the data from the at least one data location and based on the first deterministic-stochastic spectrum classification. The operations of block 1715 may be performed in accordance with examples as disclosed herein. In some examples, aspects of the operations of 1715 may be performed by a data retrieval component 1335 as described with reference to FIG. 13.

At 1720, the method may include performing a vector distance calculation between one or more first vectors associated with a vector embedding of the user input and a set of multiple second vectors associated with a set of multiple vector embeddings of the at least one data location to identify the data based on one or more second vectors of the set of multiple second vectors that are associated with the data and satisfy a vector distance threshold. The operations of block 1720 may be performed in accordance with examples as disclosed herein. In some examples, aspects of the operations of 1720 may be performed by a vector embedding component 1355 as described with reference to FIG. 13.

At 1725, the method may include retrieving the data that is associated with the one or more second vectors of the set of multiple second vectors. The operations of block 1725 may be performed in accordance with examples as disclosed herein. In some examples, aspects of the operations of 1725 may be performed by a data retrieval component 1335 as described with reference to FIG. 13.

At 1730, the method may include transmitting, based on the first deterministic-stochastic spectrum classification and the user input, an input to a large language model. The operations of block 1730 may be performed in accordance with examples as disclosed herein. In some examples, aspects of the operations of 1730 may be performed by an LLM component 1340 as described with reference to FIG. 13.

At 1735, the method may include presenting a response to the user input, where the response is based on a combination of an output of the large language model and the data retrieved from the at least one data location. The operations of block 1735 may be performed in accordance with examples as disclosed herein. In some examples, aspects of the operations of 1735 may be performed by a response component 1345 as described with reference to FIG. 13.

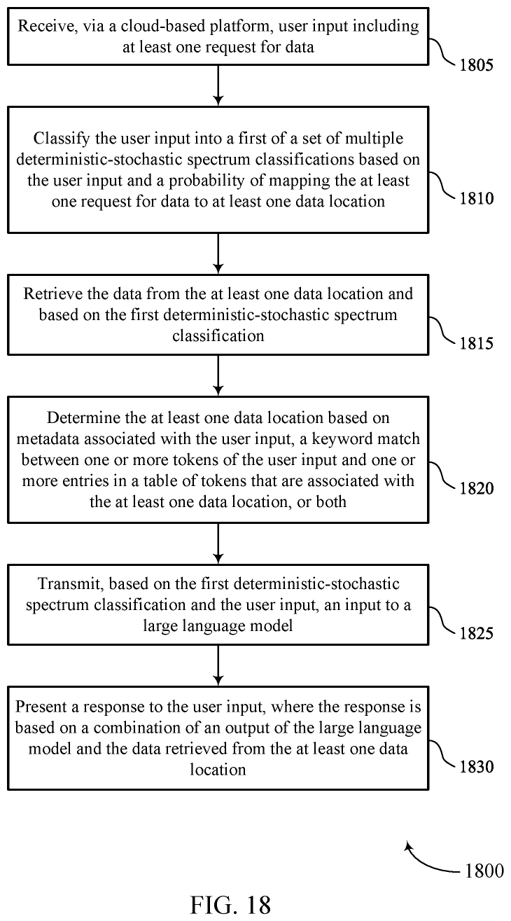

FIG. 18 shows a flowchart illustrating a method 1800 that supports a large language model controller in accordance with examples as disclosed herein. The operations of the method 1800 may be implemented by an application server or its components as described herein. For example, the operations of the method 1800 may be performed by an application server as described with reference to FIGS. 1 through 14. In some examples, an application server may execute a set of instructions to control the functional elements of the application server to perform the described functions. Additionally, or alternatively, the application server may perform aspects of the described functions using special-purpose hardware.

At 1805, the method may include receiving, via a cloud-based platform, user input including at least one request for data. The operations of block 1805 may be performed in accordance with examples as disclosed herein. In some examples, aspects of the operations of 1805 may be performed by a user input component 1325 as described with reference to FIG. 13.

At 1810, the method may include classifying the user input into a first of a set of multiple deterministic-stochastic spectrum classifications based on the user input and a probability of mapping the at least one request for data to at least one data location. The operations of block 1810 may be performed in accordance with examples as disclosed herein. In some examples, aspects of the operations of 1810 may be performed by a spectrum classification component 1330 as described with reference to FIG. 13.

At 1815, the method may include retrieving the data from the at least one data location and based on the first deterministic-stochastic spectrum classification. The operations of block 1815 may be performed in accordance with examples as disclosed herein. In some examples, aspects of the operations of 1815 may be performed by a data retrieval component 1335 as described with reference to FIG. 13.

At 1820, the method may include determining the at least one data location based on metadata associated with the user input, an explicit action indication in the user input, a matching rule, a machine-learning derived match, a keyword match between one or more tokens of the user input and one or more entries in a table of tokens that are associated with the at least one data location, or any combination thereof. The operations of block 1820 may be performed in accordance with examples as disclosed herein. In some examples, aspects of the operations of 1820 may be performed by a data retrieval component 1335 as described with reference to FIG. 13.

At 1825, the method may include transmitting, based on the first deterministic-stochastic spectrum classification and the user input, an input to a large language model. The operations of block 1825 may be performed in accordance with examples as disclosed herein. In some examples, aspects of the operations of 1825 may be performed by an LLM component 1340 as described with reference to FIG. 13.

At 1830, the method may include presenting a response to the user input, where the response is based on a combination of an output of the large language model and the data retrieved from the at least one data location. The operations of block 1830 may be performed in accordance with examples as disclosed herein. In some examples, aspects of the operations of 1830 may be performed by a response component 1345 as described with reference to FIG. 13.

A method for data processing is described. The method may include receiving, via a cloud-based platform, user input including at least one request for data, classifying the user input into a first of a set of multiple deterministic-stochastic spectrum classifications based on the user input and a probability of mapping the at least one request for data to at least one data location, retrieving the data from the at least one data location and based on the first deterministic-stochastic spectrum classification, transmitting, based on the first deterministic-stochastic spectrum classification and the user input, an input to a large language model, and presenting a response to the user input, where the response is based on a combination of an output of the large language model and the data retrieved from the at least one data location.

An apparatus for data processing is described. The apparatus may include at least one processor, at least one memory coupled with the at least one processor, and instructions stored in the at least one memory. The instructions may be executable by the at least one processor to cause the apparatus to receive, via a cloud-based platform, user input including at least one request for data, classify the user input into a first of a set of multiple deterministic-stochastic spectrum classifications based on the user input and a probability of mapping the at least one request for data to at least one data location, retrieve the data from the at least one data location and based on the first deterministic-stochastic spectrum classification, transmit, based on the first deterministic-stochastic spectrum classification and the user input, an input to a large language model, and present a response to the user input, where the response is based on a combination of an output of the large language model and the data retrieved from the at least one data location.

Another apparatus for data processing is described. The apparatus may include means for receiving, via a cloud-based platform, user input including at least one request for data, means for classifying the user input into a first of a set of multiple deterministic-stochastic spectrum classifications based on the user input and a probability of mapping the at least one request for data to at least one data location, means for retrieving the data from the at least one data location and based on the first deterministic-stochastic spectrum classification, means for transmitting, based on the first deterministic-stochastic spectrum classification and the user input, an input to a large language model, and means for presenting a response to the user input, where the response is based on a combination of an output of the large language model and the data retrieved from the at least one data location.

A non-transitory computer-readable medium storing code for data processing is described. The code may include instructions executable by a processor to receive, via a cloud-based platform, user input including at least one request for data, classify the user input into a first of a set of multiple deterministic-stochastic spectrum classifications based on the user input and a probability of mapping the at least one request for data to at least one data location, retrieve the data from the at least one data location and based on the first deterministic-stochastic spectrum classification, transmit, based on the first deterministic-stochastic spectrum classification and the user input, an input to a large language model, and present a response to the user input, where the response is based on a combination of an output of the large language model and the data retrieved from the at least one data location.

In some examples of the method, apparatuses, and non-transitory computer-readable medium described herein, the large language model may be a publicly accessible large language model.

In some examples of the method, apparatuses, and non-transitory computer-readable medium described herein, the large language model may be a private large language model stored within the cloud-based platform.

Some examples of the method, apparatuses, and non-transitory computer-readable medium described herein may further include operations, features, means, or instructions for presenting an indication of the first deterministic-stochastic spectrum classification with the response.

In some examples of the method, apparatuses, and non-transitory computer-readable medium described herein, retrieving the data may include operations, features, means, or instructions for identifying, based on the user input, one or more external services that may be external to the cloud-based platform and that may be capable of providing the data, transmitting one or more queries to the one or more external services, receiving the data from the one or more external services, and where the at least one data location includes one or more data locations associated with the one or more external services.

Some examples of the method, apparatuses, and non-transitory computer-readable medium described herein may further include operations, features, means, or instructions for identifying the one or more external services includes performing a vector distance calculation between one or more first vectors associated with a vector embedding of the user input and a set of multiple second vectors associated with one or more vector embeddings of one or more descriptions of a set of multiple external services that include the one or more external services to identify the one or more external services based on one or more second vectors of the set of multiple second vectors that may be associated with the one or more external services and satisfy a vector distance threshold and receiving the data from the one or more external services includes receiving one or more responses to the one or more queries that include the data that may be associated with the one or more second vectors of the set of multiple second vectors.

In some examples of the method, apparatuses, and non-transitory computer-readable medium described herein, retrieving the data may include operations, features, means, or instructions for performing a vector distance calculation between one or more first vectors associated with a vector embedding of the user input and a set of multiple second vectors associated with a set of multiple vector embeddings of the at least one data location to identify the data based on one or more second vectors of the set of multiple second vectors that may be associated with the data and satisfy a vector distance threshold and retrieving the data that may be associated with the one or more second vectors of the set of multiple second vectors.

Some examples of the method, apparatuses, and non-transitory computer-readable medium described herein may further include operations, features, means, or instructions for determining the at least one data location based on metadata associated with the user input, an explicit action indication in the user input, a matching rule, a machine-learning derived match, a keyword match between one or more tokens of the user input and one or more entries in a table of tokens that may be associated with the at least one data location, or any combination thereof.

Some examples of the method, apparatuses, and non-transitory computer-readable medium described herein may further include operations, features, means, or instructions for selecting the first deterministic-stochastic spectrum classification based on a mapping between one or more data retrieval actions associated with the data and one or more of the set of multiple deterministic-stochastic spectrum classifications, the mapping based on a specificity measure of the user input.

Some examples of the method, apparatuses, and non-transitory computer-readable medium described herein may further include operations, features, means, or instructions for classifying the user input into the first deterministic-stochastic spectrum classification based on a classification bias towards a deterministic classification.

Some examples of the method, apparatuses, and non-transitory computer-readable medium described herein may further include operations, features, means, or instructions for ranking one or more of the set of multiple deterministic-stochastic spectrum classifications based on a classification bias towards a deterministic classification, where classifying the user input into the first deterministic-stochastic spectrum classification may be based on the ranking.

Some examples of the method, apparatuses, and non-transitory computer-readable medium described herein may further include operations, features, means, or instructions for selecting the first deterministic-stochastic spectrum classification based on the at least one data location.

Some examples of the method, apparatuses, and non-transitory computer-readable medium described herein may further include operations, features, means, or instructions for retrieving the data from a structured data service, a tenant search service, a semantic search service, a segmentation service, a messaging service, an email service, a prediction service, a territory management services, a sales service, a mapping service, a document service, a commerce service, one or more data connectors, or any combination thereof.

The following provides an overview of aspects of the present disclosure:

Aspect 1: A method for data processing, comprising: receiving, via a cloud-based platform, user input comprising at least one request for data: classifying the user input into a first of a plurality of deterministic-stochastic spectrum classifications based at least in part on the user input and a probability of mapping the at least one request for data to at least one data location: retrieving the data from the at least one data location and based at least in part on the first deterministic-stochastic spectrum classification: transmitting, based at least in part on the first deterministic-stochastic spectrum classification and the user input, an input to a large language model; and presenting a response to the user input, where the response is based at least in part on a combination of an output of the large language model and the data retrieved from the at least one data location.

Aspect 2: The method of aspect 1, wherein the large language model is a publicly accessible large language model.

Aspect 3: The method of any of aspects 1 through 2, wherein the large language model is a private large language model stored within the cloud-based platform.

Aspect 4: The method of any of aspects 1 through 3, further comprising: presenting an indication of the first deterministic-stochastic spectrum classification with the response.

Aspect 5: The method of any of aspects 1 through 4, wherein retrieving the data comprises: identifying, based at least in part on the user input, one or more external services that are external to the cloud-based platform and that are capable of providing the data; transmitting one or more queries to the one or more external services; and receiving the data from the one or more external services: wherein the at least one data location comprises one or more data locations associated with the one or more external services.

Aspect 6: The method of aspect 5, wherein identifying the one or more external services comprises performing a vector distance calculation between one or more first vectors associated with a vector embedding of the user input and a plurality of second vectors associated with one or more vector embeddings of one or more descriptions of a plurality of external services that comprise the one or more external services to identify the one or more external services based at least in part on one or more second vectors of the plurality of second vectors that are associated with the one or more external services and satisfy a vector distance threshold; and receiving the data from the one or more external services comprises receiving one or more responses to the one or more queries that comprise the data that is associated with the one or more second vectors of the plurality of second vectors.

Aspect 7: The method of any of aspects 1 through 6, wherein retrieving the data comprises: performing a vector distance calculation between one or more first vectors associated with a vector embedding of the user input and a plurality of second vectors associated with a plurality of vector embeddings of the at least one data location to identify the data based at least in part on one or more second vectors of the plurality of second vectors that are associated with the data and satisfy a vector distance threshold; and retrieving the data that is associated with the one or more second vectors of the plurality of second vectors.

Aspect 8: The method of any of aspects 1 through 7, further comprising: determining the at least one data location based at least in part on metadata associated with the user input, an explicit action indication in the user input, a matching rule, a machine-learning derived match, a keyword match between one or more tokens of the user input and one or more entries in a table of tokens that are associated with the at least one data location, or any combination thereof.

Aspect 9: The method of any of aspects 1 through 8, further comprising: selecting the first deterministic-stochastic spectrum classification based at least in part on a mapping between one or more data retrieval actions associated with the data and one or more of the plurality of deterministic-stochastic spectrum classifications, the mapping based at least in part on a specificity measure of the user input.

Aspect 10: The method of any of aspects 1 through 9, further comprising: classifying the user input into the first deterministic-stochastic spectrum classification based at least in part on a classification bias towards a deterministic classification.

Aspect 11: The method of any of aspects 1 through 10, further comprising: ranking one or more of the plurality of deterministic-stochastic spectrum classifications based at least in part on a classification bias towards a deterministic classification, wherein classifying the user input into the first deterministic-stochastic spectrum classification is based at least in part on the ranking.

Aspect 12: The method of any of aspects 1 through 11, further comprising: selecting the first deterministic-stochastic spectrum classification based at least in part on the at least one data location.

Aspect 13: The method of any of aspects 1 through 12, further comprising: retrieving the data from a structured data service, a tenant search service, a semantic search service, a segmentation service, a messaging service, an email service, a prediction service, a territory management services, a sales service, a mapping service, a document service, a commerce service, one or more data connectors, or any combination thereof.

Aspect 14: An apparatus for data processing, comprising at least one processor: at least one memory coupled with the at least one processor; and instructions stored in the at least one memory and executable by the at least one processor to cause the apparatus to perform a method of any of aspects 1 through 13.

Aspect 15: An apparatus for data processing, comprising at least one means for performing a method of any of aspects 1 through 13.

Aspect 16: A non-transitory computer-readable medium storing code for data processing, the code comprising instructions executable by a processor to perform a method of any of aspects 1 through 13.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary.” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components.” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
receiving, via a cloud-based platform, user input comprising at least one request for data;
classifying the user input into a first of a plurality of deterministic-stochastic spectrum classifications based at least in part on the user input and a probability of mapping the at least one request for data to at least one data location;
retrieving the data from the at least one data location and based at least in part on the first deterministic-stochastic spectrum classification;
transmitting, based at least in part on the first deterministic-stochastic spectrum classification and the user input, an input to a large language model; and
presenting a response to the user input, where the response is based at least in part on a combination of an output of the large language model and the data retrieved from the at least one data location.

2. The method of claim 1, wherein the large language model is a publicly accessible large language model.

3. The method of claim 1, wherein the large language model is a private large language model stored within the cloud-based platform.

4. The method of claim 1, further comprising:
presenting an indication of the first deterministic-stochastic spectrum classification with the response.

5. The method of claim 1, wherein retrieving the data comprises:
identifying, based at least in part on the user input, one or more external services that are external to the cloud-based platform and that are capable of providing the data;
transmitting one or more queries to the one or more external services; and
receiving the data from the one or more external services;
wherein the at least one data location comprises one or more data locations associated with the one or more external services.

6. The method of claim 5, wherein:
identifying the one or more external services comprises performing a vector distance calculation between one or more first vectors associated with a vector embedding of the user input and a plurality of second vectors associated with one or more vector embeddings of one or more descriptions of a plurality of external services that comprise the one or more external services to identify the one or more external services based at least in part on one or more second vectors of the plurality of second vectors that are associated with the one or more external services and satisfy a vector distance threshold; and
receiving the data from the one or more external services comprises receiving one or more responses to the one or more queries that comprise the data that is associated with the one or more second vectors of the plurality of second vectors.

7. The method of claim 1, wherein retrieving the data comprises:
performing a vector distance calculation between one or more first vectors associated with a vector embedding of the user input and a plurality of second vectors associated with a plurality of vector embeddings of the at least one data location to identify the data based at least in part on one or more second vectors of the plurality of second vectors that are associated with the data and satisfy a vector distance threshold; and
retrieving the data that is associated with the one or more second vectors of the plurality of second vectors.

8. The method of claim 1, further comprising:
determining the at least one data location based at least in part on metadata associated with the user input, an explicit action indication in the user input, a matching rule, a machine-learning derived match, a keyword match between one or more tokens of the user input and one or more entries in a table of tokens that are associated with the at least one data location, or any combination thereof.

9. The method of claim 1, further comprising:
selecting the first deterministic-stochastic spectrum classification based at least in part on a mapping between one or more data retrieval actions associated with the data and one or more of the plurality of deterministic-stochastic spectrum classifications, the mapping based at least in part on a specificity measure of the user input.

10. The method of claim 1, further comprising:
classifying the user input into the first deterministic-stochastic spectrum classification based at least in part on a classification bias towards a deterministic classification.

11. The method of claim 1, further comprising:
ranking one or more of the plurality of deterministic-stochastic spectrum classifications based at least in part on a classification bias towards a deterministic classification, wherein classifying the user input into the first deterministic-stochastic spectrum classification is based at least in part on the ranking.

12. The method of claim 1, further comprising:
selecting the first deterministic-stochastic spectrum classification based at least in part on the at least one data location.

13. The method of claim 1, further comprising:
retrieving the data from a structured data service, a tenant search service, a semantic search service, a segmentation service, a messaging service, an email service, a prediction service, a territory management services, a sales service, a mapping service, a document service, a commerce service, one or more data connectors, or any combination thereof.

14. An apparatus for data processing, comprising:
at least one processor;
at least one memory coupled with the at least one processor; and
instructions stored in the at least one memory and executable by the at least one processor to cause the apparatus to:
receive, via a cloud-based platform, user input comprising at least one request for data;
classify the user input into a first of a plurality of deterministic-stochastic spectrum classifications based at least in part on the user input and a probability of mapping the at least one request for data to at least one data location;
retrieve the data from the at least one data location and based at least in part on the first deterministic-stochastic spectrum classification;
transmit, based at least in part on the first deterministic-stochastic spectrum classification and the user input, an input to a large language model; and
present a response to the user input, where the response is based at least in part on a combination of an output of the large language model and the data retrieved from the at least one data location.

15. The apparatus of claim 14, wherein the instructions are further executable by the at least one processor to cause the apparatus to:
present an indication of the first deterministic-stochastic spectrum classification with the response.

16. The apparatus of claim 14, wherein the instructions to retrieve the data are executable by the at least one processor to cause the apparatus to:
identify, based at least in part on the user input, one or more external services that are external to the cloud-based platform and that are capable of providing the data;
transmit one or more queries to the one or more external services; and
receive the data from the one or more external services;
wherein the at least one data location comprise one or more data locations associated with the one or more external services.

17. The apparatus of claim 14, wherein the instructions to retrieve the data are executable by the at least one processor to cause the apparatus to:
perform a vector distance calculation between one or more first vectors associated with a vector embedding of the user input and a plurality of second vectors associated with a plurality of vector embeddings of the at least one data location to identify the data based at least in part on one or more second vectors of the plurality of second vectors that are associated with the data and satisfy a vector distance threshold; and
retrieve the data that is associated with the one or more second vectors of the plurality of second vectors.

18. The apparatus of claim 14, wherein the instructions are further executable by the at least one processor to cause the apparatus to:
determine the at least one data location based at least in part on metadata associated with the user input, an explicit action indication in the user input, a matching rule, a machine-learning derived match, a keyword match between one or more tokens of the user input and one or more entries in a table of tokens that are associated with the at least one data location, or any combination thereof.

19. The apparatus of claim 14, wherein the instructions are further executable by the at least one processor to cause the apparatus to:
classify the user input into the first deterministic-stochastic spectrum classification based at least in part on a classification bias towards a deterministic classification.

20. A non-transitory computer-readable medium storing code for data processing, the code comprising instructions executable by one or more processors to:
receive, via a cloud-based platform, user input comprising at least one request for data;
classify the user input into a first of a plurality of deterministic-stochastic spectrum classifications based at least in part on the user input and a probability of mapping the at least one request for data to at least one data location;
retrieve the data from the at least one data location and based at least in part on the first deterministic-stochastic spectrum classification;
transmit, based at least in part on the first deterministic-stochastic spectrum classification and the user input, an input to a large language model; and
present a response to the user input, where the response is based at least in part on a combination of an output of the large language model and the data retrieved from the at least one data location.
